(19) United States
(12) Patent Application Publication
(10) Pub. No.: US 2015/0247018 A1
(43) Pub. Date: Sep. 3, 2015

(54) BIODEGRADATION OF PETROLEUM-BASED PLASTICS

(71) Applicants: Jun YANG, (US); Yu YANG, (US); Weimin WU, (US)

(72) Inventors: Jun Yang, Beijing (CN); Yu Yang, Beijing (CN); Weimin Wu, Okemos, MI (US)

(21) Appl. No.: 14/440,045

(22) PCT Filed: Oct. 31, 2012
(86) PCT No.: PCT/CN2012/083789

§ 371 Date: Apr. 30, 2015

(51) Int. Cl. C08J 11/10

(52) U.S. Cl. CPC C08J 11/10; C08J 2325/06; C08J 2323/06

(57) ABSTRACT

The present disclosure generally relates to biological processes for degrading waste plastics and recycled plastics, and more specifically to novel isolated insects capable of degrading petroleum-based plastics, bacterial strains capable of degrading petroleum-based plastics, and microbial consortia including such strains. The present disclosure also relates to compositions including such strains and microbial consortia, and to methods of using such strains, microbial consortia, and insects.

### FIELD OF THE INVENTION

The present disclosure generally relates to biological processes for degrading waste plastics, and more specifically to novel isolated insects capable of degrading petroleum-based plastics, novel bacterial strains capable of degrading petroleum-based plastics, and microbial consortia including such strains. The present disclosure also relates to compositions including such strains, microbial consortia, and enzymes; and to methods of using such insects, strains, microbial consortia, and enzymes.

### BACKGROUND

Thousands of tons of synthetic petroleum-based plastics waste accumulate in the environment every day, resulting in growing landfills and escalating waste disposal costs and deterioration of the environment. A significant portion of the petroleum-based plastics waste in landfills comes from personal consumption. At present, the global average plastic consumption per capita is 38.38 kg per year. In the USA, Europe, Japan and China, the per capita plastic consumption is 150 kg, 120 kg, 100 kg, and 39 kg, respectively. Most of an individual's used plastic products are discarded as solid waste and contribute the municipal waste stream. In the USA, waste plastics comprised 13% of the 240.3 million tons of municipal solid waste (MSW) (EPA report 2009, USA). In Europe and Japan, the yearly production of MSW was 220 million and 55 million tons, in which waste plastics comprised 15-25% and 11.8%, respectively (Eurostat. 2008; Environ. Manage., 2007 (40):12-19). In China, waste plastics accounted for 12% of the 212 million tons of MSW per year (China Statistical Yearbook, 2001-2007; J Environ. Manage., 2010 (91): 1623-1633).

Recent advances in biochemistry have yielded new forms of renewable and biodegradable bioplastics that can be produced by biological and chemical processes utilizing sugars, starch, and cellulose produced in plants and other agricultural sources. However, given the high cost of producing these bioplastics, petroleum-based plastics derived from fossil-fuels remain the predominant form of plastics worldwide, and thus are the primary form of waste plastic accumulating in the environment.

Due to its negligible or even absent degradation in the environment, discarded petroleum-based plastics waste has been accumulating at an ever increasing rate in soils, sediments, and bodies of water. Not only is this devastating to landscapes, but waste plastics cause serious environmental pollution. Presently, the major methods for disposal of waste plastic products include burying in landfills, incineration and recycling which can be accomplished through physical and chemical methods (Macromolecules symposium, 2006, 245-246:599-606) (Waste Management, 2009, 29:2625-2643).

As an alternative to disposal, a potential strategy to address the accumulating plastic waste problem includes investigating the contribution of microorganisms on the biodegradation of petroleum-based plastics. For example, tests on petroleum-based polymers (e.g., PE, PS, PVC) that had been buried for 32 years found low level degradation for low density PE, but found no evidence of biodegradation for PS and PVC (Otake et al. J. Appl. Polym. Sci. 1995, 56:1789). The rate of degradation for low density PE was 0.5% over 2 years as measured by evolved ¹⁴CO₂ using an isotopic tracer (Albertsson et al., J Appl. Polym. Sci. 1978, 22(12):3419).

Additionally, several microorganisms have also been shown to be capable of biodegrading PE, PP and PS (Kaplan et al., Appl. Environ. Microbiol. 1979, 38(3):551; Sivan et al., Biodegradation, 2008 19:851; Sivan et al., Appl Microbiol Biotechnol., 2006, 72: 346-352; Atiq et al. Afr. J. Microbiol. Res. 2010, 4(14): 1537; Otake et al., J. Appl. Polym. Sci. 1995, 56:1789; Nakamiya et al., J. Ferment. Bioeng. 1997, 84(5): 480; Cacciari et al., Appl. Environ. Microbiol. 1993, 59(11): 3695; Arkatkar et al., Int. Biodeter. Biodegrad. 2009, 63: 106; Wasserbauer et al., Biomaterials. 1990, 11(1): 36; Kawai et al., Polym. Degrad. Stabil., 2002, 76(1): 129; Kathiresan, Rev. Biol. Trop. 2003, 51(3): 629; Seneviratne et al., Current Science, 2006, 90(1): 20; Sudhakara et al., Int. Biodeter. Biodegrad. 2008, 61(3): 203; Nada et al., J. Appl. Sci. Environ. Manage. 2010, 14(2): 57; Nanda and Sahu, New York Science Journal, 2010, 3, 95; Albertsson et al., J. Appl. Polym. Sci. 1978, 22(12): 3419; Albertsson et al., J. Appl. Polym. Sci. 1980, 25(8): 1655; Iiyoshi et al. Journal of Wood Science, 1998, 44(3): 222; and Shah et al., Afr. J. Microbiol. Res. 2009, 3(10): 658).

However, a major problem with these microorganisms is the slow rate of plastic degradation achieved by the microorganisms. For example, mixed cultures of several bacterial and fungal strains isolated from sludge, contaminated soils, and marine sediments showed biodegradation of low density PE, albeit as an extremely slow rate. The highest rate of degradation was reported for Pseudomonas and Rhodococcus isolates, which removed PE and PP by 40.5% and 37.5%, respectively, on a per weight basis over a 3 week period (Nadnda and Sahu, New York Science Journal, 2010, 3, 95-98). Additionally, low level biodegradation of PS was described using mixed microbial cultures isolated from sludge, soils, manure, garbage with the highest rate of biodegradation reported at 0.55% over 11 weeks as measured by ¹⁴C isotopic tracer (Kaplan et al., Appl. Environ. Microbiol. 1979, 38(3): 551). Researchers described a Rhodococcus ruber isolate capable of reducing PS film by 0.8% (per weight basis) over an 8 week period; however, there was no direct measure of PS biodegradation other than difference in initial and final weight (Mor and Sivan, Biodegradation, 2008, 19:851). Atiq et al. reported the growth of an isolate on PS film and the appearance of 1-phenyl 1,2 ethandiol in the medium, although no significant chemical changes to the surface of the PS film were detected by FTIR analysis (Afr. J. Microbiol. Res. 2010, 4(14):1537). It is difficult to judge whether PS was really being degraded or the observation of 1-phenyl 1,2 ethandiol was due to degradation of PS monomers (which are biodegradable) normally present as a small component of PS.

Because of high molecular weight, complicated structure, and hydrophobicity, petroleum-based plastics, such as polystyrene (PS), polyethylene (PE), polypropylene (PP), polyvinyl chloride (PVC), polyethylene terephthalate (PET), and polycarbonate (PC) are generally considered slow and difficult to biodegrade in natural environments. Despite reports of petroleum-based plastic-degrading microbes, the rates at which degradation have been reported thus far have not been shown to be sufficiently robust to have commercial utility.

To date, there has yet to be described an adequate biological method, process, system, reactor or facility with the capability of biodegrading petroleum-based plastics at high rates (e.g., in less than 30 days) and at any scale (bench, pilot, or industrial). Nor has the use of biomass products derived from the degradation of petroleum-based plastics been described for use as industrial and agronomic resources including agronomic feedstocks, nutrient sources, organic fertilizers and/or biofuels.

Accordingly, there exists a need to develop improved means of degrading petroleum-based plastics once their usefulness has expired, and in particular to develop more efficient biological systems that are capable of degrading petroleum-based plastics at high enough rates, in less than about 30 days, in order to make the process commercially useful. Additionally, it would also be advantageous to have methods of utilizing the biomass derived from the biodegradation of these plastics.

All references, publications, and patent applications disclosed herein are hereby incorporated by reference in their entirety.

### SUMMARY OF THE INVENTION

In order to meet this need, the present disclosure provides bacterial cells, consortia of several bacterial strains, compositions containing such cells, and insects capable of degrading petroleum-based plastics. Moreover, the present disclosure is based, at least in part, on the surprising discovery of novel bacterial strains and insects that can metabolize and degrade one or more petroleum-based plastics at rates far greater than what has been previously described. Bacterial strains of the present disclosure can biodegrade an amount of plastic that is from about 100 to about 10,000-fold greater than the dry weight of the cells within 10 to 30 days. Insects of the present disclosure can biodegrade an amount of plastic that is at least 10-fold greater than the weight of the insect within about 10 days. Advantageously, the insects of the present disclosure gain biomass from the consumption of petroleum-based plastics, and the biomass gained can be used to derive biomass products. Additionally, the bacteria and insects of the present disclosure provide new, cost-effective and practical ways to degrade petroleum-based plastics. Moreover, extracellular enzymes were identified as depolymerizing agents that break plastics into soluble organic matter that can be further degraded.

Accordingly, certain aspects of the present disclosure provide one or more isolated petroleum-based plastic-degrading bacterial cells of a bacterial strain, where the cells degrade one or more petroleum-based plastics in an amount that is at least 100 fold greater than the dry weight of the cells when the cells are grown in the presence of the one or more petroleum-based plastics for a period of time that ranges from about 10 days to about 90 days at a temperature range of about 25° C. to about 37° C., at a pH range of about 6.0 to about 7.5, and a dissolved oxygen content range of about 0.3 mg/L to about 4.0 mg/L. In certain embodiments, the one or more bacterial cells exhibit the characteristics of cells of bacterial strain YP1 deposited with CGMCC as Accession No. 6318. Alternatively, the one or more bacterial cells exhibit the characteristics of cells of bacterial strain YT1 deposited with CGMCC as Accession No. 6319. In other embodiments, the one or more bacterial cells exhibit the characteristics of cells of bacterial strain Y3 deposited with CGMCC as Accession No. X3. In other embodiments, the one or more bacterial cells exhibit the characteristics of cells of bacterial strain Y4 deposited with CGMCC as Accession No. X4. In other embodiments, the one or more bacterial cells exhibit the characteristics of cells of bacterial strain Y5 deposited with CGMCC as Accession No. X5. In other embodiments, the one or more bacterial cells exhibit the characteristics of cells of bacterial strain Y6 deposited with CGMCC as Accession No. X6.

Other aspects of the present disclosure provide one or more isolated bacterial cells of a bacterial strain exhibiting all the identifying characteristics of a strain deposited with CGMCC as Accession No. 6318; variants of the strain deposited with CGMCC as Accession No. 6318, where the variants have all the identifying characteristics of the CGMCC No. 6318 strain; and mutants of the strain deposited with CGMCC as Accession No. 6318, where the mutants have all the identifying characteristics of the CGMCC No. 6318 strain.

Other aspects of the present disclosure provide one or more isolated bacterial cells of a bacterial strain exhibiting all the identifying characteristics of a strain deposited with CGMCC as Accession No. 6318.

Other aspects of the present disclosure provide one or more isolated bacterial cells of an isolated bacterial strain deposited with CGMCC as Accession No. 6318.

Other aspects of the present disclosure provide one or more isolated bacterial cells of a bacterial strain exhibiting all the identifying characteristics of a strain deposited with CGMCC as Accession No. 6319; variants of the strain deposited with CGMCC as Accession No. 6319, where the variants have all the identifying characteristics of the CGMCC No. 6319 strain; and mutants of the strain deposited with CGMCC as Accession No. 6319, where the mutants have all the identifying characteristics of the CGMCC No. 6319 strain.

Other aspects of the present disclosure provide one or more isolated bacterial cells of a bacterial strain exhibiting all the identifying characteristics of a strain deposited with CGMCC as Accession No. 6319.

Other aspects of the present disclosure provide one or more isolated bacterial cells of an isolated bacterial strain deposited with CGMCC as Accession No. 6319.

Other aspects of the present disclosure provide one or more isolated bacterial cells of a bacterial strain exhibiting all the identifying characteristics of a strain deposited with CGMCC as Accession No. X3; variants of the strain deposited with CGMCC as Accession No. X3, where the variants have all the identifying characteristics of the CGMCC No. X3 strain; and mutants of the strain deposited with CGMCC as Accession No. X3, where the mutants have all the identifying characteristics of the CGMCC No. X3 strain.

Other aspects of the present disclosure provide one or more isolated bacterial cells of a bacterial strain exhibiting all the identifying characteristics of a strain deposited with CGMCC as Accession No. X3.

Other aspects of the present disclosure provide one or more isolated bacterial cells of an isolated bacterial strain deposited with CGMCC as Accession No. X3.

Other aspects of the present disclosure provide one or more isolated bacterial cells of a bacterial strain exhibiting all the identifying characteristics of a strain deposited with CGMCC as Accession No. X4; variants of the strain deposited with CGMCC as Accession No. X4, where the variants have all the identifying characteristics of the CGMCC No. X4 strain; and mutants of the strain deposited with CGMCC as Accession No. X4, where the mutants have all the identifying characteristics of the CGMCC No. X4 strain.

Other aspects of the present disclosure provide one or more isolated bacterial cells of a bacterial strain exhibiting all the identifying characteristics of a strain deposited with CGMCC as Accession No. X4.

Other aspects of the present disclosure provide one or more isolated bacterial cells of an isolated bacterial strain deposited with CGMCC as Accession No. X4.

Other aspects of the present disclosure provide one or more isolated bacterial cells of a bacterial strain exhibiting all the identifying characteristics of a strain deposited with CGMCC as Accession No. X5; variants of the strain deposited with CGMCC as Accession No. X5, where the variants have all the identifying characteristics of the CGMCC No. X5 strain; and mutants of the strain deposited with CGMCC as Accession No. X5, where the mutants have all the identifying characteristics of the CGMCC No. X5 strain.

Other aspects of the present disclosure provide one or more isolated bacterial cells of a bacterial strain exhibiting all the identifying characteristics of a strain deposited with CGMCC as Accession No. X5.

Other aspects of the present disclosure provide one or more isolated bacterial cells of an isolated bacterial strain deposited with CGMCC as Accession No. X5.

Other aspects of the present disclosure provide one or more isolated bacterial cells of a bacterial strain exhibiting all the identifying characteristics of a strain deposited with CGMCC as Accession No. X6; variants of the strain deposited with CGMCC as Accession No. X6, where the variants have all the identifying characteristics of the CGMCC No. X6 strain; and mutants of the strain deposited with CGMCC as Accession No. X6, where the mutants have all the identifying characteristics of the CGMCC No. X6 strain.

Other aspects of the present disclosure provide one or more isolated bacterial cells of a bacterial strain exhibiting all the identifying characteristics of a strain deposited with CGMCC as Accession No. X6.

Other aspects of the present disclosure provide one or more isolated bacterial cells of an isolated bacterial strain deposited with CGMCC as Accession No. X6.

In certain embodiments that may be combined with any of the preceding embodiments, the one or more bacterial cells are capable of degrading one or more petroleum-based plastics. In certain embodiments that may be combined with any of the preceding embodiments, the bacterial cells are isolated from an insect selected from Tenebrio molitor Linne, Zophobas morio, and Plodia interpunctella. In certain embodiments that may be combined with any of the preceding embodiments, the one or more petroleum-based plastics are waste petroleum-based plastics. In certain embodiments that may be combined with any of the preceding embodiments, the one or more petroleum-based plastics are selected from polystyrene (PS), polyethylene (PE), polypropylene (PP), polyvinyl chloride (PVC), polyethylene terephthalate (PET), and polycarbonate (PC). In certain embodiments, the one or more bacterial cells degrade an amount of the one or more petroleum-based plastic that ranges from about 100 grams of the one or more petroleum-based plastics per gram of dry weight of the cells to about 10,000 grams of the one or more petroleum-based plastics per gram of dry weight of the cells.

Other aspects of the present disclosure provide a composition containing the one or more bacterial cells of any of the preceding embodiments. Other aspects of the present disclosure provide a composition containing one or more cells of at least one of a bacterial strain selected from YT1, YP1, Y3, Y4, Y5, Y6, and combinations thereof. In certain embodiments, the at least one or more cells are of at least two bacterial strains, at least three bacterial strains, at least four bacterial strains, at least five bacterial strains, or six of the bacterial strains selected from YT1, YP1, Y3, Y4, Y5, and Y6.

In certain embodiments that may be combined with any of the preceding embodiments, the composition further contains one or more petroleum-based plastics, where the one or more bacterial cells are cultured with the one or more petroleum-based plastics.

Other aspects of the present disclosure provide an isolated microbial consortium containing the one or more bacterial cells of any of the preceding embodiments. Other aspects of the present disclosure provide an isolated microbial consortium containing one or more bacterial cells of a bacterial strain selected from YT1, YP1, Y3, Y4, Y5, Y6, and combinations thereof.

Other aspects of the present disclosure provide a composition containing the isolated microbial consortium of any of the preceding embodiments. In certain embodiments, the composition further contains one or more petroleum-based plastics, where the isolated microbial consortium is cultured with the one or more petroleum-based plastics.

Other aspects of the present disclosure provide a method of degrading one or more petroleum-based plastics, by: culturing the composition of any of the preceding embodiments with one or more petroleum-based plastics under conditions sufficient for the composition to degrade the one or more petroleum-based plastics.

In certain embodiments, the one or more petroleum-based plastics are the sole carbon source. In certain embodiments that may be combined with any of the preceding embodiments, the one or more petroleum-based plastics are waste petroleum-based plastics. In certain embodiments that may be combined with any of the preceding embodiments, the one or more petroleum-based plastics are selected from polystyrene (PS), polyethylene (PE), polypropylene (PP), polyvinyl chloride (PVC), polyethylene terephthalate (PET), and polycarbonate (PC). In certain embodiments that may be combined with any of the preceding embodiments, the composition is cultured for a period of time sufficient to degrade the one or more petroleum-based plastics. In certain embodiments that may be combined with any of the preceding embodiments, the composition is cultured for a period of time that ranges from about 10 days to about 90 days. In certain embodiments that may be combined with any of the preceding embodiments, the composition is cultured at a temperature range of about 15° C. to about 45° C.

Other aspects of the present disclosure provide a method of degrading one or more petroleum-based plastics, by: contacting larvae of at least one petroleum-based plastic-degrading insect with one or more petroleum-based plastics; and growing the larva with the one or more petroleum-based plastics under conditions sufficient for the larvae to degrade the one or more petroleum-based plastics, thereby yielding a degraded petroleum-based plastic product.

In certain embodiments, the larvae are grown with the one or more petroleum-based plastics for a period of time sufficient to degrade an amount of the one or more petroleum-based plastics that is at least 10 fold greater than the weight of the larvae. In certain embodiments, the larvae are grown with the one or more petroleum-based plastics for a period of time that ranges from about 2 hours to about 480 hours, from about 2 hours to about 360 hours, from about 2 hours to about 240 hours, from about 2 hours to about 120 hours, from about 2 hours to about 96 hours, from about 2 hours to about 72 hours, from about 2 hours to about 48 hours, or from about 2 hours to about 24 hours. In certain embodiments that may be combined with any of the preceding embodiments, the larvae are provided at a larval density that ranges from about 2.0 kg/m² to about 10 kg/m². In certain embodiments that may be combined with any of the preceding embodiments, the larvae are provided at a larval density that ranges from about 3.5 kg/m² to about 6.0 kg/m². In certain embodiments that may be combined with any of the preceding embodiments, the larvae are grown with the one or more petroleum-based plastics at a temperature that ranges from about 20° C. to about 35° C. In certain embodiments that may be combined with any of the preceding embodiments, the larvae are grown with the one or more petroleum-based plastics at a temperature that ranges from about 25° C. to about 28° C. In certain embodiments that may be combined with any of the preceding embodiments, the larvae are grown with the one or more petroleum-based plastics at a moisture content that ranges from about 60% to about 99%. In certain embodiments that may be combined with any of the preceding embodiments, the larvae are grown with the one or more petroleum-based plastics at a moisture content that ranges from about 80% to about 90%. In certain embodiments that may be combined with any of the preceding embodiments, the larvae are grown with the one or more petroleum-based plastics at a light to dark ratio of about 16:8 or a light to dark ratio of about 14:10. In certain embodiments that may be combined with any of the preceding embodiments, the larvae convert the one or more petroleum-based plastics to carbon dioxide (CO₂). In certain embodiments that may be combined with any of the preceding embodiments, the degraded petroleum-based plastic product has a molecular weight that is at least 20% lower than the molecular weight of a corresponding petroleum-based plastic that has not been degraded. In certain embodiments that may be combined with any of the preceding embodiments, the method further includes growing the larvae with a source of nutrients. In certain embodiments, the source of nutrients is selected from vegetables, leafy vegetables, fruits, tubers, roots, fresh vegetable leaves, potatoes, carrots, corn, and combinations thereof. In certain embodiments that may be combined with any of the preceding embodiments, the nutrients are selected from nitrogen, phosphorous, a vitamin, water, and combinations thereof. In certain embodiments that may be combined with any of the preceding embodiments, the one or more petroleum-based plastics are waste petroleum-based plastics. In certain embodiments that may be combined with any of the preceding embodiments, the one or more petroleum-based plastics are selected from polystyrene (PS), polyethylene (PE), polypropylene (PP), polyvinyl chloride (PVC), polyethylene terephthalate (PET), and polycarbonate (PC). In certain embodiments that may be combined with any of the preceding embodiments, the petroleum-based plastic-degrading insect is a grain beetle. In certain embodiments that may be combined with any of the preceding embodiments, the petroleum-based plastic-degrading insect is selected from Tenebrio molitor Linne, Zophobas morio, and Plodia interpunctella.

Other aspects of the present disclosure provide a method of producing a biomass product, by: contacting larvae of at least one petroleum-based plastic-degrading insect with one or more petroleum-based plastics; and growing the larva with the one or more petroleum-based plastics under conditions sufficient for the larvae to metabolize the one or more petroleum-based plastics, where the larvae utilize the metabolized one or more petroleum-based plastics to produce at least one biomass product.

In certain embodiments, the larvae are grown with the one or more petroleum-based plastics for a period of time that ranges from about 2 hours to about 480 hours, from about 2 hours to about 360 hours, from about 2 hours to about 240 hours, from about 2 hours to about 120 hours, from about 2 hours to about 96 hours, from about 2 hours to about 72 hours, from about 2 hours to about 48 hours, or from about 2 hours to about 24 hours. In certain embodiments that may be combined with any of the preceding embodiments, the larvae are provided at a larval density that ranges from about 2.0 kg/m² to about 10 kg/m². In certain embodiments that may be combined with any of the preceding embodiments, the larvae are provided at a larval density that ranges from about 3.5 kg/m² to about 6.0 kg/m². In certain embodiments that may be combined with any of the preceding embodiments, the larvae are grown with the one or more petroleum-based plastics at a temperature that ranges from about 20° C. to about 35° C. In certain embodiments that may be combined with any of the preceding embodiments, the larvae are grown with the one or more petroleum-based plastics at a temperature that ranges from about 25° C. to about 28° C. In certain embodiments that may be combined with any of the preceding embodiments, the larvae are grown with the one or more petroleum-based plastics at a moisture content that ranges from about 60% to about 99%. In certain embodiments that may be combined with any of the preceding embodiments, the larvae are grown with the one or more petroleum-based plastics at a moisture content that ranges from about 80% to about 90%. In certain embodiments that may be combined with any of the preceding embodiments, the larvae are grown with the one or more petroleum-based plastics at a light to dark ratio of about 16:8 or a light to dark ratio of about 14:10. In certain embodiments that may be combined with any of the preceding embodiments, the method further includes growing the larvae with a source of nutrients. In certain embodiments, the source of nutrients is selected from vegetables, leafy vegetables, fruits, tubers, roots, fresh vegetable leaves, potatoes, carrots, corn, and combinations thereof. In certain embodiments that may be combined with any of the preceding embodiments, the nutrients are selected from nitrogen, phosphorous, vitamin, water, and combinations thereof. In certain embodiments that may be combined with any of the preceding embodiments, the method further includes growing the larvae with a juvenile hormone and/or neotenin to stimulate larval growth. In certain embodiments that may be combined with any of the preceding embodiments, the one or more petroleum-based plastics are waste petroleum-based plastics. In certain embodiments that may be combined with any of the preceding embodiments, the one or more petroleum-based plastics are selected from polystyrene (PS), polyethylene (PE), polypropylene (PP), polyvinyl chloride (PVC), polyethylene terephthalate (PET), and polycarbonate (PC). In certain embodiments that may be combined with any of the preceding embodiments, the petroleum-based plastic-degrading insect is a grain beetle. In certain embodiments that may be combined with any of the preceding embodiments, the petroleum-based plastic-degrading insect is selected from Tenebrio molitor Linne, Zophobas morio, and Plodia interpunctella. In certain embodiments that may be combined with any of the preceding embodiments, the at least one biomass product is selected from lipids, fatty acids, proteins, chitin, and combinations thereof. In certain embodiments that may be combined with any of the preceding embodiments, the method further includes harvesting the larvae. In certain embodiments, the harvested larvae are utilized as feed. In certain embodiments, the at least one biomass product is extracted from the harvested larvae. In certain embodiments, the at least one biomass product is utilized as feedstock in the production of at least one commodity chemical. In certain embodiments, the at least one commodity chemical is a biofuel. In certain embodiments, the at least one biomass product is utilized as feedstock in the production of an emulsifier, a surfactant, a lubricant, a flocculant, a transformer oil, food, feed, a pharmaceutical, a fertilizer, a cleaning product, a healthcare product, a cosmetics product, or combinations thereof. In certain embodiments that may be combined with any of the preceding embodiments, the method further includes harvesting excrement from the larvae. In certain embodiments, the excrement is utilized as fertilizer.

### BRIEF DESCRIPTION OF THE DRAWINGS

FIG. 1 depicts an exemplary process for the harvesting of insects and production of biomass products;

FIG. 2 depicts the weight gain of insects, and the fatty acid and protein fraction of the insect bodies on different diets. In the figure, “Raw”=insects that were not fed; “EPS-1”=insects that were fed with EPS as the only food source; “EPS-P-1”=insects that were fed with EPS and potato; and “EPS-L-1”=insects that were fed with EPS and vegetable leaves;

FIG. 3 depicts the CO₂ production from mineralization of expanded polystyrene (EPS) during insect feeding. The curve with the solid square shows accumulated CO₂ from larvae on EPS. The curve with the solid triangles shows estimated net CO₂ production from EPS. The curve with the solid circles shows accumulated CO₂ from control larvae that were not fed;

FIG. 4 depicts the molecular weight distribution of expanded polystyrene (EPS) and insect frass after biodegradation;

FIG. 5 depicts the TG curves for EPS and insect frass after biodegradation;

FIG. 6A depicts the FTIR spectra of gaseous species evolved during the thermal decomposition of EPS. FIG. 6B depicts the FTIR spectra of gaseous species evolved during the thermal decomposition of insect frass after biodegradation of EPS;

FIG. 7 depicts the FTIR spectra of EPS and insect frass after biodegradation;

FIG. 8A depicts the molecular weight distribution of PE and insect frass after biodegradation. FIG. 8B depicts the FTIR spectra of PE and insect frass after biodegradation of PE;

FIG. 9A depicts the SEM observation of PE film corroded by bacterial strain YP1 isolated from insect Plodia interpunctella. FIG. 9B depicts a higher magnification SEM observation of PE film corroded by bacterial strain YP1 isolated from insect Plodia interpunctella;

FIG. 10A depicts the SEM observation of a control PE film. FIG. 10B depicts the SEM observation of a PE film rinsed with water after 28 day of incubation. FIG. 10C depicts the SEM observation of a PE film showing the attachment of bacterial isolate YT1 after 28 days of incubation;

FIG. 11 depicts the 16S rRNA sequence of the YP1 strain (SEQ ID NO: 1);

FIG. 12 depicts the 16S rRNA sequence of the YT1 strain (SEQ ID NO: 2).

### DETAILED DESCRIPTION

### Overview

The following description sets forth exemplary methods, parameters and the like. It should be recognized, however, that such description is not intended as a limitation on the scope of the present disclosure but is instead provided as a description of exemplary embodiments.

The present disclosure relates to one or more insects, and variants thereof, that are capable of degrading petroleum-based plastics. Furthermore, the present disclosure relates to bacterial isolates, mutants thereof, and variants thereof, that may be isolated from the one or more insects and that are capable of degrading petroleum-based plastics. The present disclosure further relates to microbial consortia, and compositions containing such bacterial isolates and consortia that are capable of degrading petroleum-based plastics.

Surprisingly, it was found that the insects of the present disclosure are capable of not only degrading petroleum-based plastics through ingestion, but of gaining biomass from the consumption of petroleum-based plastics as well. The conversion of petroleum-based plastics to insect biomass is useful to derive biomass products from the insects. Accordingly, the present disclosure provides methods of growing insects that degrade petroleum-based plastics and of deriving biomass products from insects growing on petroleum-based plastics. The petroleum-based plastics may be from industrial and/or municipal sources.

In addition, it was found that bacteria isolated from the gut of these insects were able to use petroleum-based plastics as the sole carbon source and to degrade the petroleum-based plastics in the process. Thus, the present disclosure further describes methods of growing bacterial isolates and microbial consortia that degrade petroleum-based plastics. The petroleum-based plastics may be from industrial and/or municipal sources.

The present disclosure provides new, cost-effective, and practical methods to dispose of waste petroleum-based plastics and reduce environmental pollution by waste petroleum-based plastics. The present discourse not only provides new methods for the disposal of waste petroleum-based plastics, but also provides methods for recovering biomass products from the insects that degrade the waste petroleum-based plastics. The present disclosure addresses the unmet need of having a scalable, biological process for the degradation of waste petroleum-based plastics.

The present disclosure also indicates the presence of extracellular enzymes from the gut of insects of the present disclosure, and from bacterial isolates of the present disclosure. The enzymes can depolymerize plastics into soluble fragments, and therefore provide new methods for the production of depolymerizing agents to break down plastic.

### DEFINITIONS

Unless defined otherwise, all scientific and technical terms are understood to have the same meaning as commonly used in the art to which they pertain. For the purpose of the present disclosure, the following terms are defined.

As used herein, the term “mutant of a strain deposited with the China General Microbiological Culture Collection (CGMCC) as Accession No. [X]” refers to a naturally occurring or engineered variant of the parental strain deposited with CGMCC as Accession No. [X]. “[X]” can be any Accession No., such as X1, X2, X3, etc. Examples of Accession Nos. are listed in Table 1. The parental strain is defined herein as the original isolated strain prior to mutagenesis.

In certain embodiments, a variant of a strain deposited with CGMCC as Accession No. [X] may be a strain having all the identifying characteristics of the strain deposited with CGMCC as Accession No. [X] and can be identified as having a genome that hybridizes under conditions of high stringency to the genome of the CGMCC No. [X] strain. “Hybridization” refers to a reaction in which a genome reacts to form a complex with another genome that is stabilized via hydrogen bonding between the bases of the nucleotide residues that make up the genomes. The hydrogen bonding may occur by Watson-Crick base pairing, Hoogstein binding, or in any other sequence-specific manner. The complex may comprise two strands forming a duplex structure, three or more strands forming a multi-stranded complex, a single self-hybridizing strand, or any combination of these. Hybridization reactions can be performed under conditions of different “stringency.” In general, a low stringency hybridization reaction is carried out at about 40° C. in 10×SSC or a solution of equivalent ionic strength/temperature. A moderate stringency hybridization is typically performed at about 50° C. in 6×SSC, and a high stringency hybridization reaction is generally performed at about 60° C. in 1×SSC. In other embodiments, a variant of a strain deposited with CGMCC as Accession No. [X] may also be a strain having a genomic sequence that is greater than 85%, more preferably greater than 90% or more preferably greater than 95% sequence identity to the genome of the CGMCC No. [X] strain.

As used herein, the term “petroleum-based plastic(s)” refers to a wide range of synthetic, fossil-fuel- or petrochemical-derived carbon-containing polymers. Petroleum-based plastics can be classified by their chemical structure and may include, without limitation, acrylics, polyesters, silicones, polyurethanes, halogenated plastics, aromatic polymers, and polyolefins.

As used herein, the term “petroleum-based plastic-degrading insect” refers to an insect of the present disclosure, at any growth of stage (juvenile larva to adult insect), that is capable of consuming, metabolizing and/or degrading any one or more of the petroleum-based plastics of the present disclosure.

As used herein, the term “petroleum-based plastic-degrading bacteria” refers to bacterial strains, one or more bacterial cells, culture(s) of bacterial cells, and consortia of bacterial strains that are capable of utilizing one or more petroleum-based plastics as the sole carbon source.

As used herein, the term “isolated bacterial cell(s),” “isolated bacterial strain,” and “isolated bacteria” refer to bacterial cells or bacteria that have been separated from a natural source of the bacterial cells or bacteria, such as from the gut of petroleum-based plastic-degrading insects. Additionally, “isolated bacterial cell(s),” “isolated bacterial strain,” and “isolated bacteria” can also include purified bacterial cell(s), a purified bacterial strain, and/or purified bacteria. As used herein, “purified bacterial cell(s),” “purified bacterial strain,” and “purified bacteria” refer to bacterial cells or bacteria that is substantially separated from, and enriched relative to other microorganisms, such as yeasts, molds, and/or other bacterial species or strains, found in the natural source from which the bacterial cells or bacteria were obtained. Methods of isolating bacteria are well known in the art.

As used herein, the term “microbial consortia” refers to a combination and/or mixture of any two or more of the petroleum-based plastic-degrading bacterial strains of the present disclosure.

As used herein and in the appended claims, the singular forms “a,” “an,” and “the” include plural reference unless the context clearly indicates otherwise.

It is understood that aspect and variations of the invention described herein include “consisting” and/or “consisting essentially of” aspects and variations.

Petroleum-Based Plastics

Certain aspects of the present disclosure relate to isolated insects and bacteria of the present disclosure are capable of metabolizing petroleum-based plastics.

Suitable sources of petroleum-based plastics of the present disclosure include, without limitation, residues and/or unprocessed material from industrial and municipal sources including landfills, dumping sites, farmland, recycling centers, trash from commercial buildings and residential areas, waste from treatment plants, incinerators, polymer cracking or conversion facilities, polymer gasification facilities, and other facilities/processes for recovery of petroleum-based plastics that are known in the art, or any combination thereof. Suitable petroleum-based plastics may be isolated from any of the aforementioned sources. For example, landfill waste may be sorted to isolate petroleum-based plastics. Methods of isolating plastics, such as petroleum-based plastics, are well known in the art.

One non-limiting example of isolating petroleum-based plastics from a residential or commercial source includes the use of materials recovery facilities. Materials recovery facilities (MRFs) can either be “clean” or “dirty” MRFs. A clean MRF accepts materials that have been separated and sorted, preferably at the residential and commercial level. There are “single stream” and “dual stream” MRFs. Single stream MRFs contain mixed sources of recyclable materials such as paper fibers, plastics, metals, glass and others. In dual stream MRFs, paper goods are separated from glass, metals, and plastics. Dirty MRFs accept mixed solid waste and separate the waste at the facility using both automated and manual sorting methods. New types of MRFs called “wet” MRFs utilize water to separate and clean the input recycling stream. Wet MRFs may separate out the biological organic and to allow biological treatments such as composting or anaerobic digestion. Automated (mechanical) sorting at MRFs is accomplished through the use of machines that removed recyclables from a mixed waste stream using a combination of conveyers, magnets, trommels, and shredders. Advanced mechanical sorting may use spectrometry to help identify and sort recyclables. Wet MRFs may use density and floatation to recover and wash recyclables. Once recyclables, such as petroleum-based plastics, are sorted, they may be shredded into small pieces and compacted into bails to facilitate handling and subsequent transportation. Additionally, shredded plastic may be washed and ground into small flakes. This washing process removes the desired plastic from contaminating residual matter. Plastic that has been shredded and/or washed may further be melted into granules or pellets for use in manufacturing facilities to make new petroleum-based plastics products. Petroleum-based plastics need not be isolated from MRFs, and any one skilled in the art of plastic recycling and/or plastic processing would be aware of commonly used methods to isolate petroleum-based plastics.

Any petroleum-based plastic known in art may be used as a source of plastic for the growth of petroleum-based plastic-degrading insects and/or petroleum-based plastic-degrading bacteria of the present disclosure. Examples of suitable petroleum-based plastics include, without limitation, polystyrene (PS), polyethylene (PE), polypropylene (PP), polyvinyl chloride (PVC), polyethylene terephthalate (PET), and polycarbonate (PC). In other embodiments, petroleum-based plastics include, without limitation, expanded polystyrene (EPS), expanded polyethylene (EPE), high density polyethylene (HDPE), low density polyethylene (LDPE), expanded polypropylene (EPP), expanded polyvinylchloride, PET foam, polymethylmethacrylate (PMMA), acrylonitrile butadiene styrene (ABS), polyamide (Nylon), polyimide (PI), polyamide-imide (PAI), polytetrafluoroethylene (PTFE), polyetherimide (PEI), polyether ether ketone (PEEK), polyaryletherketone (PAEK), self-reinforced polyphenylene (SRP), polysulfone (PSF), polyurethane (PU), melamine formaldehyde (MF), and phenol formaldehyde (PF). In certain preferred embodiments, the petroleum-based plastics include, without limitation, (PS), polyethylene (PE), polypropylene (PP), polyvinyl chloride (PVC), polyethylene terephthalate (PET), and polycarbonate (PC).

Additionally, suitable petroleum-based plastics include combinations of petroleum-based plastics, including, without limitation, a combination of 1 or more, 2 or more, 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, 18 or more, 19 or more, 20 or more, 21 or more, 22 or more, 23 or more, 24 or more, 25 or more, or 26 or more of the petroleum-based plastics of the present disclosure.

### Petroleum-Based Plastic-Degrading Insects

Other aspects of the present disclosure relate to insects capable of degrading petroleum-based plastics. Any petroleum-based plastic-degrading insect may be used in the methods of the present disclosure for degrading petroleum-based plastics.

Suitable petroleum-based plastic-degrading insects include, without limitation, beetles, tobacco beetles, flour beetles, grain beetles, wheat beetles, meal worms, and cockroaches. Preferably, the petroleum-based plastic-degrading insects are ground beetles of the family Carabidae, darkling beetles of the family Tenebrionidae, and snout moths from the family Pyralidae.

Petroleum-based plastic-degrading insects may be identified by their ability to degrade one or more petroleum-based plastics of the present disclosure. In certain embodiments, methods to identify petroleum-based plastics degrading insects include incubating the insect in question with petroleum-based plastics as the carbon source and monitoring survival and growth of said insect. Petroleum-based plastics degrading insects not only survive on petroleum-based plastics, but are able to gain biomass from the consumption of the petroleum-based plastic.

Methods for identifying and screening petroleum-based plastic degradation in insects may be adapted from known methods used to monitor petroleum-based degradation by microbes and degradation of plastics in the environment. For example, the American Society for Testing and Materials (ASTM) and the International Organization for Standardization (ISO) provide a set of standards for assessing biodegradation of plastics that include, without limitation, ASTM G22-76(1996), ASTM D6954-04, ASTM D5988-03, ISO 14855-2:2007, and ISO 17556:2003. In some embodiments, the degree of biodegrading capability may be monitored by simply monitoring weight gain of the insects, and the weight of plastic consumed over a period of time or may involve more analytical methods. Examples of analytical methods to monitor the degradation of petroleum-based plastics include, without limitation, morphological, rheological, gravimetric, spectroscopic, and chromatographic methods. Examples of morphological analyses include, without limitation, photonic microscopy, electronic microscopy, atomic force microscope, polarization microscopy, and “yellowness” indices. Examples of rheological analyses include, without limitation, tensile measurements, X-ray diffraction, differential scanning calorimetery, and thermogravimetric analysis. Examples of spectroscopic methods include, without limitation, fluorescence, UV-visible, FTIR, RMN, and mass spectrometry. Examples of chromatographic methods include, without limitation, gel permeation, gas phase, and high performance liquid chromatography.

In some embodiments, the biodegradation of the petroleum-based plastics are monitored by the incorporation of the petroleum-based plastic's constituent elements into the biomass of the insect and/or bacterial isolate of the present disclosure. In some embodiments, isotopically labeled petroleum-based plastics may include isotopically labeled elements, without limitation, such as ¹⁴C, ¹³C, ¹⁸O, ¹⁷O, ¹⁵N, ³⁶S, ³⁵S, ³⁴S, and ³³S, ³³P and ³²P. The isotopically-labeled elements may be used to track the incorporated of these aforementioned isotopes into the biomass of the petroleum-based plastic-degrading insect. In further embodiments, the CO₂ output of the insects may be monitored. Insects fed a diet of petroleum-based plastics that continue to produce CO₂ after an extended period of time may derive CO₂ from the degradation of carbon-containing petroleum-based plastics. In some embodiments, the CO₂ output is monitored in a closed chamber with influxing air being absent in CO₂. Effluent air is bubbled through a solution of sodium hydroxide and the CO₂ is precipitated out and weighed. The amount of CO₂ produced may be directly correlated to the amount of petroleum-based plastics degraded by the insects. In some embodiments, the ¹³CO₂ production of the insect is monitored, and if the insect is grown in the presence of ¹³C-labeled petroleum-based plastics, the degradation of petroleum-based plastics may be directly correlated to the production of ¹³CO₂. In some embodiments, the ¹³CO₂ production of the bacterial isolate and soluble ¹³C fragment are monitored, and if the bacterial isolate is grown in the presence of ¹³C-labeled petroleum-based plastics, the degradation of petroleum-based plastics may be directly correlated to the production of ¹³CO₂. The depolymerization of petroleum-based plastics may be directly correlated to the production of soluble ¹³C fragments. In some embodiments, the soluble ¹³C fragments are monitored, and if the enzyme is reacted with ¹³C-labeled petroleum-based plastics, the depolymerization of petroleum-based plastics may be directly correlated to the production of soluble ¹³C fragments.

In yet other embodiments, petroleum-based plastic-degrading insects may be identified by analyses of insect frass (excrement) after feeding the insects petroleum-based plastics. Frass from insects that degrade petroleum-based plastics, and not merely and ingest and pass petroleum-based plastics, may show one or more chemical modifications of the petroleum-based plastics when the frass is analyzed. In some embodiments, the frass from insects fed petroleum-based plastics is analyzed using, without limitation, analytical methods such as GC, GC/MS, LC/MS/MS, HPLC, FTIR, FPLC, NMR, DTG, and GPC.

In some embodiments, petroleum-based plastic-degrading insects may be identified as being members of the Coleoptera order and Lepidoptera order. Taxonomic designations are frequently edited and updated, and as such, any person skilled in the art would easily consult an authoritative taxonomic reference, such as the Integrated Taxonomic Information System, or The National Center for Biotechnology Information to obtain the latest taxonomic designations and groupings.

In some embodiments, petroleum-based plastic-degrading insects of the present disclosure may include taxonomic members of the Coleoptera order and Lepidoptera order, which include, without limitation, the suborder members Adephaga, Archostemata, Myxophaga and Polyphaga. Taxonomic members of the Polyphaga suborder include the infraorder members Bostrichiformia, Cucujiformia, Elateriformia, Scarabeiformia, and Staphyliniformia. Taxonomic members of the Cucujiformia infraorder include the superfamily members Chrysomeloidea, Cleroidea, Cucujoidea, Curculionoidea, Lymexyloidea, and Tenebrionoidea. Members of the Tenebrionoidea superfamily include the family members Aderidae, Anthicidae, Archeocrypticidae, Boridae, Chalcodryidae, Ciidae, Melandryidae, Meloidae, Mordellidae, Mycetophagidae, Mycteridae, Oedemeridae, Perimylopidae, Prostomidae, Pterogeniidae, Pyrochroidae, Pythidae, Rhipiphoridae, Salpingidae, Scraptiidae, Stenotrachelidae, Synchroidae, Tenebrionidae, Tetratomidae, Trachelostenidae, Trictenotomidae, Ulodidae, and Zopheridae. Members of the Tenebrionidae family include subfamily members Alleculinae, Coelometopinae, Diaperinae, Lagriinae, Palorinae, Phrenapatinae, Pimeliinae, Tenebrioninae, and Zolodininae. Members of the Tenebrionidae family also include genus members Adelina, Alphitobius, Amarygmus, Ammophorus, Archeoglenes, Blapstinus, Diaperis, Epantius, Eutochia, Gnathocerus, Gonocephalum, Hypophloeus, Latheticus, Lobometopon, Lyphia, Mesomorphus, Myrmechixenus, Palembus, Palorus, Phaleria, Platydema, Sciophagus, Tagalus, Tenebrio, Tribolium, and Uloma. In some embodiments, petroleum-based plastic-degrading insects are taxonomic members of the Tenebrio and Tribolium genera.

In some embodiments, petroleum-based plastic-degrading insects of the present disclosure include the Tenebrio, Tribolium and Plodia genera, such as wheat and flour beetles. Members of the Tenebrio genus include Tenebrio molitor, and Tenebrio obscures. Members of the Tribolium genus include Tribolium anaphe, Tribolium audax, Tribolium brevicornis, Tribolium castaneum, Tribolium confusum, Tribolium destructor, Tribolium freemani, Tribolium madens, and Tribolium sp. DEH-1995.

Preferably, the petroleum-based plastic-degrading insects are Tenebrio molitor Linne, Zophobas morio, and Plodia interpunctella. The isolated Tenebrio molitor Linne insect can be classified as phylum: Arthropoda, class: Insecta, order: Coleoptera, and family: Carabidae. The isolated Zophobas morio insect can be classified as phylum: Arthropoda, class: Insecta, order: Coleoptera, and family: Tenebrionidae. The isolated Plodia interpunctella insect can be classified as phylum: Arthropoda, class: Insecta, order: Lepidoptera, Glade: Ditrysia, and family: Pyralidae. These three insects have been taxonomically identified and are capable of degrading petroleum based plastics.

Identification of isolated insects was performed firstly by collecting information of main characterizes of age, legs, wings, feelers and mouthparts. This information was then compared with a taxonomic database to identify the isolated insects.

Growth Conditions

Petroleum-based plastic-degrading insects of the present disclosure may be grown under varying conditions including, without limitation, varying temperature, light, moisture, insect density, nutrients and hormones. Variations in the aforementioned conditions may impact growth and the ability to degrade petroleum-based plastics.

In one embodiment, isolated insects of the present disclosure may be grown in growth chambers that provide control over temperature, hours of light, moisture content, and insect density, nutrient supplementation and application of hormones. In another embodiment, isolated insects of the present disclosure may be grown in enclosures under outdoor, ambient conditions.

In some embodiments, petroleum-based plastic-degrading insects of the present disclosure may be contacted with one or more petroleum-based plastics under conditions sufficient for the insects to degrade the one or more petroleum-based plastics and thereby yield a degraded petroleum-based plastic product. In some embodiments, the petroleum-based plastic-degrading insects degrade at least about 1 to 50 times their body weight in plastic, at least about 2 to 40 times their body weight in plastic, at least about 3 to 30 times their body weight in plastic, at least about 4 to 20 times their body weight in plastic, at least about 5 to 15 times their body weight in plastic, at least about 6 to 14 times their body weight in plastic, at least about 7 to 13 times their body weight in plastic, or at least about 8 to 12 times their body weight in plastic. In some embodiments, the petroleum-based plastic-degrading insects degrade at least about 9 to 11 times their body weight in plastic. In some embodiments, the petroleum-based plastic-degrading insects degrade at least about 10 times their body weight in plastic. In yet other embodiments, the petroleum-based plastic-degrading insects degrade less than about 10 times their body weight in plastic. In some embodiments, the petroleum-based plastic-degrading insects degrades at least about 1, at least about 2, at least about 3, at least about 4, at least about 5, at least about 6, at least about 7, at least about 8, at least about 9, at least about 10, at least about 11, at least about 12, at least about 13, at least about 14, at least about 15, at least about 16, at least about 17, at least about 18, at least about 19, at least about 20, at least about 25, at least about 30, at least about 35, at least about 40, at least about 45, or at least about 50 times their body weight in plastic. Preferably, the petroleum-based plastic-degrading insects degrade at least about 10 times their body weight in plastic. In reference to the body weight of a petroleum-based plastic-degrading insect, “about X times” an insect's body weight means plus or minus 0.2 times the body weight of an insect. For example, an amount of degraded plastic of about 10 times an insect's body weight ranges from 9.8 times the insects body weight to 10.2 times the insects body weight.

In some embodiments, the period of time petroleum-based plastic-degrading insects of the present disclosure may be contacted with petroleum-based plastics varies between 2 to 480 hours, between about 2 to 360 hours, between about 2 to 240 hours, between about 2 to 120 hours, between about 2 to 96 hours, between about 2 to 72 hours between about 2 to 48 hours, or between about 2 to 24 hours. In some embodiments, the insects are contacted with the petroleum-based plastics for at least about 2, for at least about 3, for at least about 4, for at least about 5, for at least about 6, for at least about 7, for at least about 8, for at least about 9, for at least about 10, for at least about 11, for at least about 12, for at least about 13, for at least about 14, for at least about 15, for at least about 16, for at least about 17, for at least about 18, for at least about 19, for at least about 20, for at least about 21, for at least about 22, for at least about 23, for at least about 24, for at least about 25, for at least about 26, for at least about 27, for at least about 28, for at least about 29, for at least about 30, for at least about 31, for at least about 32, for at least about 33, for at least about 34, for at least about 35, for at least about 36, for at least about 37, for at least about 38, for at least about 39, for at least about 40, for at least about 41, for at least about 42, for at least about 43, for at least about 44, for at least about 45, for at least about 46, for at least about 47, for at least about 48, for at least about 54, for at least about 60, for at least about 66, for at least about 72, for at least about 80, for at least about 88, for at least about 96, for at least about 104, for at least about 112, for at least about 120, for at least about 128, for at least about 136, for at least about 144, for at least about 152, for at least about 160, for at least about 168, for at least about 176, for at least about 184, for at least about 192, for at least about 200, for at least about 208, for at least about 216, for at least about 224, for at least about 232, for at least about 240, for at least about 252, for at least about 264, for at least about 276, for at least about 288, for at least about 300, for at least about 312, for at least about 324, for at least about 336, for at least about 348, for at least about 360, for at least about 372, for at least about 384, for at least about 396, for at least about 408, for at least about 420, for at least about 432, for at least about 444, for at least about 456, for at least about 468, or for at least about 480 hours. In some embodiments, the insects are contacted with the petroleum-based plastics for less than about 72 hours. In some embodiments, the insects are contact with the petroleum-based plastics for more than about 72 hours. In reference to the time for which petroleum-based plastic-degrading insects are contacted with petroleum-based plastics, “about X hours” means plus or minus 0.25 hours. For example, a period of time of about 48 hours ranges from 47.75 hours to 48.25 hours.

In some embodiments, the density at which petroleum-based plastic-degrading insects of the present disclosure may be grown in the presence of petroleum-based plastics ranges from at least about 1 kg/m² to 10 kg/m², from at least about 1 kg/m² to 8 kg/m², from at least about 2 kg/m² to 6 kg/m², from at least about 2 kg/m² to 5 kg/m², or ranges from at least about 2 kg/m² to 4 kg/m². In some embodiments, the density at which insects may be grown in the presence of petroleum-based plastics is at least about 3.5 kg/m². In some embodiments, the density at which insects may be grown in the presence of petroleum-based plastics is less than about 3.5 kg/m². In some embodiments, the range density at which insects may be grown in the presence of petroleum-based plastics is at least about 1, at least about 2, at least about 3, at least about 4, at least about 5, at least about 6, at least about 7, at least about 8, at least about 9, or at least about 10 kg/m². Preferably, the density at which insects may be grown in the presence of petroleum-based plastics is at least about 3.5 kg/m². In reference to the density at which petroleum-based plastic-degrading insects may be grown in the presence of petroleum-based plastics, “about X kg/m²” means plus or minus 0.2 kg/m². For example, a density of about 2 kg/m² ranges from 1.8 kg/m² to 2.2 kg/m².

In some embodiments, the temperature at which petroleum-based plastic-degrading insects of the present disclosure may be grown in the presence of petroleum-based plastics ranges from at least about 0° C. to 55° C., from at least about 0° C. to 50° C., from at least about 5° C. to 50° C., from at least about 10° C. to 45° C., from at least about 15° C. to 40° C., from at least about 18° C. to 37° C., from at least about 20° C. to 35° C., or from at least about 20° C. to 35° C. In some embodiments, the temperature at which insects may be grown in the presence of petroleum-based plastics is at least about 25° C. In some embodiments, the temperature at which insects may be grown in the presence of petroleum-based plastics is less than about 25° C. In some embodiments, the temperature at which insects may be grown in the presence of petroleum-based plastics is about 25° C. to 35° C. In some embodiments, the temperature at which insects may be grown in the presence of petroleum-based plastics is at least about 0° C., at least about 1° C., at least about 2° C., at least about 3° C., at least about 4° C., at least about 5° C., at least about 6° C., at least about 7° C., at least about 8° C., at least about 9° C., at least about 10° C., at least about 11° C., at least about 12° C., at least about 13° C., at least about 14° C., at least about 15° C., at least about 16° C., at least about 17° C., at least about 18° C., at least about 19° C., at least about 20° C., at least about 21° C., at least about 22° C., at least about 23° C., at least about 24° C., at least about 25° C., at least about 26° C., at least about 27° C., at least about 28° C., at least about 29° C., at least about 30° C., at least about 31° C., at least about 32° C., at least about 33° C., at least about 34° C., at least about 35° C., at least about 36° C., at least about 37° C., at least about 38° C., at least about 39° C., at least about 40° C., at least about 41° C., at least about 42° C., at least about 43° C., at least about 44° C., at least about 45° C., at least about 46° C., at least about 47° C., at least about 49° C., at least about 50° C., at least about 51° C., at least about 52° C., at least about 53° C., at least about 54° C., at least about 55° C., at least about 56° C., at least about 57° C., at least about 58° C., at least about 59° C., or at least about 60° C. Preferably, the temperature at which insects may be grown in the presence of petroleum-based plastics is about 25° C. In reference to the temperature at which petroleum-based plastic-degrading insects may be grown in the presence of petroleum-based plastics, “about X° C.” means plus or minus 0.2° C. For example, a temperature of 25° C. ranges from 24.8° C. to 25.2° C.

In some embodiments, the moisture content at which petroleum-based plastic-degrading insects of the present disclosure may be grown under in the presence of petroleum-based plastics ranges from at least about 15% to 99%, from at least about 25% to 95%, from at least about 35% to 95%, from at least about 45% to 95%, from at least about 55% to 90%, from at least about 60% to 90%, from at least about 65% to 90%, from at least about 70% to 90%, or from at least about 80% to 90%. In some embodiments, the moisture content at which the insects may be grown under in the presence of petroleum-based plastics is at least about 85%. In some embodiments, the moisture content at which the insects may be grown under in the presence of petroleum-based plastics is less than about 85%. In some embodiments, the moisture content at which the insects may be grown under in the presence of petroleum-based plastics is at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99%. Preferably, the moisture content at which the insects may be grown under in the presence of petroleum-based plastics is about 85%. In reference to the moisture content at which petroleum-based plastic-degrading insects may be grown in the presence of petroleum-based plastics, “about X %” means plus or minus 0.2%. For example, a moisture content of about 90% ranges from 89.8% to 90.2%.

In some embodiments, the number of hours of light and dark (light:dark) to which the insects may be exposed, in the presence of petroleum-based plastics, varies from at least about 0:24, from at least about 1:23, from at least about 2:22, from at least about 3:21, from at least about 4:20, from at least about 5:19, from at least about 6:18, from at least about 7:17, from at least about 8:16, from at least about 9:15, from at least about 10:14, from at least about 11:13, from at least about 12:12, from at least about 13:11, from at least about 14:10, from at least about 15:9, from at least about 16:8, from at least about 17:7, from at least about 18:6, from at least about 19:5, from at least about 20:4, from at least about 21:3, from at least about 22:2, from at least about 23:1, or from at least about 24:0 hours. Preferably, in some embodiments, the number of hours of light and dark to which the insects may be exposed, in the presence of petroleum-based plastics, varies from at least about 16:8, from at least about 15:9, or from at least about 14:10 hours. Preferably, the number of hours of light and dark to which the insects may be exposed, in the presence of petroleum-based plastics is about 16:8 hours.

In some embodiments, petroleum-based plastic-degrading insects of the present disclosure may be fed a source of nutrients in addition to the petroleum-based plastics. Supplemental nutrients may be used to provide a source of vitamins, minerals, elements, and/or moisture that the insects may need in order to have optimal growth. In some embodiments, nutrients may include, without limitation, organic matter such as bran, oatmeal, rice, wheat, vegetables, leafy vegetables, fruits, tubers, roots, bark, stems, fresh vegetable leaves, potatoes, carrots, corn, detritus, plant fibers, tomatoes, straw, apples, peas, soy powder and combinations thereof. In some embodiments, the insects of the present disclosure, in addition to the petroleum-based plastics, may be fed a source of nutrients that range from at least about 0% to 20%, from at least about 0% to 15%, from at least about 0% to 10%, from at least about 0% to 7.5%, from at least about 0% to 5%, from at least about 1% to 5%, from at least about 2% to 5%, from at least about 3% to 5%, or from at least about 4% to 5% of the total petroleum-based plastic, as measured by dry weight of the nutrients. In some embodiments the petroleum-based plastic-degrading insects of the present disclosure, in addition to the petroleum-based plastics, are fed a source of nutrients that are at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, or at least about or 20% of the total petroleum-based plastic, as measured by dry weight of the nutrients. In some embodiments the insects of the present disclosure, in addition to the petroleum-based plastics, are fed a source of nutrients that are about 5% of the total petroleum-based plastic, as measured by dry weight of the nutrients. In some embodiments the insects of the present disclosure, in addition to the petroleum-based plastics, are fed a source of nutrients that are less than about 5% of the total petroleum-based plastic, as measured by dry weight of the nutrients. In some embodiments the insects of the present disclosure, in addition to the petroleum-based plastics, are fed a source of nutrients that are at least about 2.5% of the total petroleum-based plastic, as measured by dry weight of the nutrients. Preferably, in some embodiments, the petroleum-based plastic-degrading insects of the present disclosure, in addition to the petroleum-based plastics, are fed a source of nutrients that are about 2.5% of the total petroleum-based plastic, as measured by dry weight of the nutrients.

In other embodiments, the nutrients that the petroleum-based plastic-degrading insects of the present disclosure are fed may also include, without limitation, nitrogen, phosphorus, vitamins and water. In some embodiments, vitamins include, without limitation, vitamin A, B₁, B₂, B₃, B₅, B₆, B₇, B₉, B₁₂, C, D, E, K₁, cholesterol-containing fats, and their derivatives.

Another embodiment of the present disclosure relates to applying insect hormones to stimulate the growth of larvae that may assist in the rapid metabolism of the petroleum-based plastics. Insect hormones may include insect growth hormones, and endocrine regulators. Examples of growth hormones include, without limitation, insect juvenile hormone (JH) and neotenin. As disclosed herein, about 0.005% to about 0.05% of JH or neotenin may be added to the insect food source to keep the insect in the larval stage and achieve large-sized larvae.

In some embodiments, any one of the variables of duration of contact, temperature, light:dark, moisture content, insect density, nutrient supplementation, and insect hormone application may be combined, without limitation, with the other one. Preferably, the time of contact of the insect with the petroleum-based plastics is about 72 hours, the incubation temperature is about 25° C., the number of light and darks hours is about 16:8, the moisture content is about 85%, the insect density is about 3.5 kg/m², the nutrient supplementation is about 2.5% dry weight compared to the petroleum-based plastics, and optionally the concentration of added JH or neotenin is 0.005-0.05%. Isolated insects of the present disclosure can consume, digest, metabolize and degrade at least about 10 times their weight in petroleum-based plastics. The petroleum-based plastics may include, without limitation, polystyrene (PS), polyethylene (PE), polypropylene (PP), polyvinyl chloride (PVC), polyethylene terephthalate (PET), and polycarbonate (PC).

In some embodiments, the petroleum-based plastics are fully degraded. In some embodiments, the petroleum-based plastics are partially degraded. Fully and partially degraded petroleum-based plastics may have a lower molecular weight than non-degraded petroleum-based plastic. In some embodiments, degraded petroleum-based plastics are at least about 1% to 99%, at least about 5% to 99%, at least about 10% to 90%, at least about 10% to 85%, at least about 10% to 75%, at least about 15% to 65%, at least about 15% to 50%, at least about 15% to 45%, at least about 15% to 30%, or at least about 15% to 25% lower in molecular weight than corresponding non-degraded petroleum-based plastics. In some embodiments, the petroleum-based plastics are at least about 20% lower in molecular weight than corresponding non-degraded petroleum-based plastics. In some embodiments, the petroleum-based plastics are at least about 50% lower in molecular weight than corresponding non-degraded petroleum-based plastics. In some embodiments, the petroleum-based plastics are at least about 75% lower in molecular weight than corresponding non-degraded petroleum-based plastics. In yet other embodiments, the petroleum-based plastics are at least about 90% lower in molecular weight than corresponding non-degraded petroleum-based plastics. In some embodiments, the petroleum-based plastics are at least about 1%, at least about 2%, at least about 3%, at least about 4%, at least about 5%, at least about 6%, at least about 7%, at least about 8%, at least about 9%, at least about 10%, at least about 15%, at least about 20%, at least about 25%, at least about 30%, at least about 35%, at least about 40%, at least about 45%, at least about 50%, at least about 55%, at least about 60%, at least about 65%, at least about 70%, at least about 75%, at least about 80%, at least about 85%, at least about 90%, at least about 95%, or at least about 99% lower in molecular weight than corresponding non-degraded petroleum-based plastics. Preferably, the petroleum-based plastics are at least about 20% lower in molecular weight than corresponding non-degraded petroleum-based plastics. In reference to the amount of degradation of petroleum-based plastics, “at least about” or “about” means plus or minus 0.2%.

Methods of Degrading Plastics

Certain aspects of the present disclosure relate to methods of degrading petroleum-based plastics by utilizing petroleum-based plastic-degrading insects of the present disclosure.

In certain embodiments, the present disclosure relates to methods of degrading petroleum-based plastics by contacting larvae of at least one petroleum-based plastic-degrading insect of the present disclosure; and growing the larvae with one or more petroleum-based plastics under conditions sufficient for the larvae to degrade the one or more petroleum-based plastics. In certain embodiments, the petroleum-based plastic-degrading larvae are contacted with the one or more petroleum-based plastics for a period of time sufficient to degrade an amount of plastic that is at least 10 times the body weight of the petroleum-based plastic-degrading larvae. In other embodiments, the petroleum-based plastic-degrading larvae are contacted with the one or more petroleum-based plastics for least about 2 to 480 hours. In certain embodiments, the petroleum-based plastic-degrading larvae are provided at a density of at least about 2 kg/m² to 10 kg/m². In other embodiments, the petroleum-based plastic-degrading larvae are grown with the one or more petroleum-based plastics at a temperature range of about 20° C. to 35° C. In some embodiments, the petroleum-based plastic-degrading larvae are grown with the one or more petroleum-based plastics at a moisture content range of about 60%-99%. In other embodiments, the petroleum-based plastic-degrading larvae are grown with the one or more petroleum-based plastics at a light to dark ratio ranging from about 16:8 to about 14:10. In certain embodiments, the petroleum-based plastic-degrading larvae are grown with one or more isotopically labeled petroleum-based plastics (such as ¹³C) and the production of ¹³CO₂ is monitored. In other embodiments, one or more petroleum-based plastic products are degraded that are at least 20% lower in molecular weight compared to corresponding petroleum-based plastics that are not been degraded.

In certain embodiments, the petroleum-based plastic-degrading larvae are grown with a source of nutrients. In other embodiments, the petroleum-based plastic-degrading larvae are grown with a source of nutrients. Examples of suitable nutrients include, without limitation, bran, oatmeal, rice, wheat, vegetables, leafy vegetables, fruits, tubers, roots, fresh vegetable leaves, potatoes, carrots, corn, plant fibers, straws, nitrogen, phosphorous, vitamins, water or combinations thereof. In certain embodiments, the petroleum-based plastic-degrading larvae are grown with a juvenile hormone and neotenin to stimulate larval growth. In other embodiments, the petroleum-based plastic-degrading larvae are contacted with one or more waste petroleum-based plastics. Examples of suitable waste petroleum-based plastics include, without limitation, polystyrene (PS), polyethylene (PE), polypropylene (PP), polyvinyl chloride (PVC), polyethylene terephthalate (PET), and polycarbonate (PC).

In certain embodiments, the petroleum-based plastic-degrading larvae are grain beetle larvae. Preferably, the petroleum-based plastic-degrading larvae are larvae of Tenebrio molitor Linne, Zophobas morio, and/or Plodia interpunctella insects.

Methods of Producing Biomass Products

Certain aspects of the present disclosure relate to methods of using petroleum-based plastic-degrading larvae of the present disclosure to produce one or more biomass products. In certain embodiments, methods of producing a biomass product includes contacting the petroleum-based plastic-degrading larvae with one or more petroleum-based plastics under conditions sufficient for the petroleum-based plastic-degrading insect to metabolize the one or more petroleum-based plastics, wherein the metabolized petroleum-based plastics produce at least one biomass product. In certain embodiments, the methods of producing a biomass product further includes growing the petroleum-based plastic-degrading larvae by the methods described in the section above entitled “Methods of Degrading Plastics” and further detailed in the section above entitled “Growth Conditions.”

In certain embodiments, the biomass gained by the larvae from the consumption and degradation of petroleum-based plastics may contain, without limitation, lipids, proteins, and other biological components such as chitin, or combinations thereof. In certain embodiments, methods of producing biomass product involve collecting the biomass products by harvesting the petroleum-based plastic-degrading insect. In certain embodiments the petroleum-based plastic-degrading larvae may be utilized as feed. In certain embodiments, methods of producing biomass product further include extracting at least one biomass product from the harvested petroleum-based plastic-degrading larvae. In certain embodiments, the biomass product may be utilized as feedstock for the production of at least one commodity chemical. In certain embodiments, the commodity chemical is a biofuel. In certain embodiments the biomass product may be utilized as a feedstock in the production of an emulsifier, a surfactant, a lubricant, a flocculent, electricity transformer oil, food, feed, a pharmaceutical, a fertilizer, a cleaning product, a healthcare product, a cosmetics product, or any combination thereof. In certain embodiments, the excrement (frass) of the petroleum-based plastic-degrading larvae may be harvested. In certain embodiments, the harvested petroleum-based plastic-degrading insect excrement may be used as fertilizer. In certain embodiments the biomass can be used as sources for agronomic and industrial processes and may include, without limitation, animal food/feedstock, organic fertilizer, biofuels, lipid materials, fatty acids, chitin for domestic, industrial, commercial and environmental applications.

Lipids

In certain embodiments, the methods of using petroleum-based plastic-degrading larvae to produce biomass products further include extracting the lipids from the petroleum-based plastics degrading larvae. Methods used to extract lipids are well known in the art. An exemplary, generalized, process that may be used to extract lipids from petroleum-based plastic-degrading larvae may involve, without limitation, harvesting the insect, homogenizing the insect in a polar or a non-polar solvent, add the homogenate to a non-polar solvent, mixing the homogenate well to disperse the lipids, separating the lipid-containing polar from non-polar fractions by centrifugation, removing and saving the polar fraction, cleaning the polar fraction by washing with another polar solvent, and evaporating the polar solvent to collect the lipid residue. Different protocols are optimized for different lipid types and are well known and documented in the art.

In certain embodiments, biomass-derived lipid products that may be extracted to produce biomass products include, without limitation, fatty acyls (fatty acids), glycerolipids, glycerophospholipids, sphingolipids, sterol lipids, prenol lipids, saccharolipids, and polyketides. Any person skilled in the art would consulate an authoritative database, such as LIPID MAPS Structure Database (LMSD), in order to obtain examples of lipid products that may be extracted from biomass-derived lipids.

In certain embodiments of the present disclosure fatty acyls (fatty acids) include, without limitation, fatty acids and conjugates, octadecanoids, eicosanoids, docosanoids, fatty alcohols, fatty aldehydes, fatty esters, fatty amides, fatty nitriles, fatty ethers, hydrocarbons, oxygenated hydrocarbons, fatty acyl glycosides, and other fatty acyls. Examples of glycerolipids include, without limitation, monoradylglycerols, diradylglycerols, triradylglycerols, glycosylmonoradylglycerols, glycosyldiradylglycerols, and other glycerolipids. Examples of glycerophospholipids include, without limitation, glycerophosphocholines, glycerophosphoethanolamines, glycerophosphoserines, glycerophosphoglycerols, glycerophosphoglycerophosphates, glycerophosphoinositols, glycerophosphoinositol monophosphates, glycerophosphoinositol bisphosphates, glycerophosphoinositol trisphosphates, glycerophosphates, glyceropyrophosphates, glycerophosphoglycerophosphoglycerols, cdp-glycerols, glycosylglycerophospholipids, glycerophosphoinositolglycans, glycerophosphonocholines, glycerophosphonoethanolamines, di-glycerol tetraether phospholipids (caldarchaeols), glycerol-nonitol tetraether phospholipids, oxidized glycerophospholipids, and other glycerophospholipids. Examples of sphingolipids include, without limitation, sphingoid bases, ceramides, phosphosphingolipids, phosphonosphingolipids, neutral glycosphingolipids, acidic glycosphingolipids, basic glycosphingolipids, amphoteric glycosphingolipids, arsenosphingolipids, and other sphingolipids. Examples of sterol lipids include, without limitation, sterols, steroid, secosteroids, bile acids and derivatives, steroid conjugates, and other sterol lipids. Examples of prenol lipids include, without limitation isoprenoids, quinones and hydroquinones, polyprenols, hopanoids, and other prenol lipids. Examples of saccharolipids include, without limitation, acylaminosugar, acylaminosugar glycans, acyltrehaloses, acyltrehalose glycans, other acyl sugars, and other saccharolipids. Examples of polyketides include. without limitation, linear polyketides, halogenated acetogenins, annonaceae acetogenins, macrolides and lactone polyketides, ansamycins and related polyketides, polyenes, linear tetracyclines, angucyclines, polyether polyketides, aflatoxins and related substances, cytochalasins, flavonoids, aromatic polyketides, non-ribosomal peptide/polyketide hybrids, and other polyketides.

Fatty acids are known by their common name as well as by their lipid numbers (C:D), where “C” is the number of carbon atoms in the fatty acid, and “D” is the number of double bonds the fatty acid. Some different fatty acids can have the same C:D nomenclature, but contain double bonds at different locations. Consequently, where there is ambiguity, the C:D nomenclature is paired with the symbol Δ to denote the location of the double bond. In some embodiments, saturated fatty acids present in the larvae of the present disclosure include, without limitation, capric acid (10:0), lauric acid (12:0), tridecanoic acid (13:0), myristic acid (14:0), pentadecanoic acid (15:0), palmitic acid (16:0), heptadecanoic acid (17:0), stearic acid (18:0), and arachidic acid (20:0). Some examples of unsaturated fatty acids as designated by the C:D nomenclature include, without limitation, 14:1Δ9, 16:1Δ7, 16:1Δ9, 16:2Δ1, 16:2Δ10, 17:1Δ7, 18:1Δ9, 18:2Δ9, 18:2Δ12, 18:2Δ9, 18:2Δ12, 18:2Δ15, 20:1Δ11, 20:2Δ11, and 20:2Δ13. In some embodiments, fatty acids extracted from the biomass of the present disclosure may include 1 or more, 2 or more, 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, or 18 or more fatty acids from the aforementioned group. The percent content of any one of the one or more fatty acids may range from at least about 0% to 75%, at least about 0% to 65%, at least about 0% to 50%, at least about 0% to 45%, at least about 1% to 35%, at least about 1% to 25%, at least about 1% to 20%, at least about 1% to 15%, at least about 1% to 10%, at least about 1% to 7%, or at least about 1% to 5%. The percent content of any one of the one or more fatty acids may be at least about 0%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 16%, at least about 17%, at least about 18%, at least about 19%, at least about 20%, at least about 21%, at least about 22%, at least about 23%, at least about 24%, at least about 25%, at least about 26%, at least about 27%, at least about 28%, at least about 29%, at least about 30%, at least about 31%, at least about 32%, at least about 33%, at least about 34%, at least about 35%, at least about 40%, at least about 45%, at least about 50%, at least about 55%, at least about 60%, at least about 65%, at least about 70%, or at least about 75%. In reference to the fatty acid content of the petroleum-based plastic-degrading larvae, “at least about” or “about” means plus or minus 0.2%.

Additionally, the extracted lipids of the present disclosure may be used as lubricants; fuels; electricity transformer oil; chemical feedstocks; emulsifying agents; cosmetic formulations, such as eye and face makeup; moisturizers; lotions; creams; soap; detergents; cleaning products; fragrances; shampoos; bath products; and nutritional supplements. Additionally, extracted lipids of the present disclosure find use in variety of pharmaceutical applications known in the art.

Proteins

In certain embodiments, the methods of using petroleum-based plastic-degrading larvae to produce biomass products may further include extracting proteins, or fragments thereof, from the petroleum-based plastics degrading larvae. Methods used to extract proteins are well known in the art. An exemplary, generalized, process that may be used to extract proteins from petroleum-based plastic-degrading larvae may include, without limitation, harvesting the insect, homogenizing the insect in an appropriate buffered solution to maintain the protein′(s) native state, applying a series of precipitation steps to isolate the protein or group of proteins of interest, precipitating the proteins of interest, and cleaning up the protein. Alternatively, proteins may be immediately extracted in a non-polar solvent and precipitated if the native state of the protein(s) is not of concern. In some embodiments, specific proteins may be isolated by one or more of the following, without limitation, size exclusion chromatography, ion exchange chromatography, affinity chromatography, immunoaffinity chromatography, HPLC, ultrafiltration, or the like. Different protocols are optimized for different proteins and protein types and are well known and documented in the art.

In some embodiments, the extracted proteins from the petroleum-based plastic-degrading larvae of the present disclosure may be purified enzymes, such as enzymes useful for degrading petroleum-based plastics (e.g., depolymerases and lyases). In other embodiments, the extracted proteins, or fragments thereof, may be amino acids including, without limitation, aspartate, threonine, serine, glutamate, glycine, alanine, cysteine, valine, methionine, isoleucine, leucine, tyrosine, phenylalanine, lysine, arginine, histidine, proline, glutamine, tryptophan, asparagine, ornithine, selenocysteine, and taurine. Amino acids may include at least 1 or more, 2 or more, 3 or more, 4 or more, 5 or more, 6 or more, 7 or more, 8 or more, 9 or more, 10 or more, 11 or more, 12 or more, 13 or more, 14 or more, 15 or more, 16 or more, 17 or more, 18 or more, 19 or more, 20 or more, 21 or more, or 22 or more amino acids from the aforementioned group. In some embodiments, the percent content of any one of the one or more amino acids may range from at least about 0% to 50%, at least about 1% to 30%, at least about 2% to 20%, at least about 3% to 15%, at least about 4% to 10%, at least about or 5% to 9%. The percent content of any one of the one or more amino acids may be at least about 0%, at least about 1%, at least about 2%, at least about 3%, at least about 4%, at least about 5%, at least about 6%, at least about 7%, at least about 8%, at least about 9%, at least about 10%, at least about 11%, at least about 12%, at least about 13%, at least about 14%, at least about 15%, at least about 20%, at least about 25%, at least about 30%, at least about 35%, at least about 40%, at least about 45%, or at least about 50%. In reference to the amino acid content of the petroleum-based plastic-degrading larvae, “at least about” or “about” means plus or minus 0.2%.

Additionally, the extracted proteins of the present disclosure may find use as, for example, nutritional supplements, food, feed, pharmaceuticals, healthcare products, cosmetic products, and other protein-related industries.

Chitin

In certain embodiments, the methods of using petroleum-based plastic-degrading larvae to produce biomass products may further include extracting the chitin from the petroleum-based plastics degrading larvae. Methods used to extract chitin are well known in the art and chitin is typically derived from crustaceans, however, the methods may be applicable to chitin-containing larvae as well. A conventional process generally includes grinding and treating the shells with dilute sodium hydroxide and heat to remove protein. If applicable, calcium carbonate may be removed by extraction with dilute hydrochloric acid at ambient temperatures. An optional decolorization step may be followed using bleach or peroxide, or may include extraction with ethanol and ether. At this point, the product is predominately chitin. Deacetylation to produce chitosan is typically accomplished by reacting the chitin with concentrated sodium hydroxide or potassium hydroxide and heat. Any person skilled in the art would be aware of methods to extract chitin from chitin-containing organisms, such as the petroleum-based plastic-degrading larvae of the present disclosure.

In certain embodiments, biomass-derived chitin products that may be extracted to produce biomass products include, without limitation, chitosans, chito-oligosaccharides, and glucosamine. Chitosan is the deactylated version of chitin.

Additionally, the extracted chitin of the present disclosure may find utility, without limitation, for use in a wide range of applications. Chitosan, can be made into film, and used as alternative to polyethylene and may be used in packaging, and to wrap and preserve food. Chitosan has antimicrobial properties which are useful in medical applications. Because it is non-digestible in the intestine, chitin and chitosan may be used as dietary fiber for humans and animals. Chitosan may also be used a food additive and for the encapsulation of nutraceuticals, as well as controlled drug delivery in pharmaceutical applications. Chitin and chitosan may find applications in water purification and clarification. In addition chitin products may be used as emulsifying, thickening, and stabilizing agents.

Biofuel

In certain embodiments, the methods of using petroleum-based plastic-degrading larvae to produce biomass products may further include extracting a biomass product and producing a commodity chemical therefrom. In further embodiments, the commodity chemical is one or more biofuels. In certain embodiments, biofuels may be derived from biomass conversion of, for example, solid biomass or liquid biomass. Examples of suitable biofuels include, without limitation, bioalcohol, biodiesel, biogas, and syngas. Bioethanol is an alcohol made via fermentation of carbohydrates, such as are present in the petroleum-based plastic-degrading larvae of the present disclosure. Biodiesel, another form of a biofuel, may be made from oils, fats, and lipids such as are present in the petroleum-based plastic-degrading larvae of the present disclosure. Biogas, also known as methane, may be produced through the anaerobic fermentation of the organic material, such as the petroleum-based plastic-degrading larvae of the present disclosure. Syngas is produced by the partial combustion of biomass into CO and H₂. In certain embodiments, the biofuel may be a hydrocarbon or a hydrocarbon derivative.

Hydrocarbons include, without limitation, methane, ethane, ethane, ethyne, propane, propene, propyne, cyclopropane, allene, butane, isobutene, butane, butyne, cyclobutane, methylcyclopropane, butadiene, pentane, isopentane, neopentane, pentene, pentyne, cyclopentane, methylcyclobutane, ethylcyclopropane, pentadiene, isoprene, hexane, hexane, hexyne, cyclohexane, methylcyclopentane, ethylcyclobutane, propylcyclopropane, hexadiene, heptane, heptene, heptyne, cycloheptane, methylcyclohexane, heptadiene, octane, octane, octyne, cyclooctane, octadiene, nonane, nonene, nonyne, cyclononane, nonadiene, decane, decene, decyne, cyclodecane, and decadiene.

“Hydrocarbon derivatives” as used herein are organic compounds of carbon and at least one other element that is not hydrogen. Hydrocarbon derivatives include, without limitation, alcohols (e.g., butanol, ethanol); organic acids; esters; ketones; aldehydes; amino acids; and gases.

Commodity chemicals and/or biofuels of the present disclosure, including without limitation, bioalcohol, biodiesel, electricity transformer oil, biogas, syngas, hydrocarbon, and hydrocarbon derivative, may be derived by any one of several methods. Any person skilled in the art would be aware of such methods to derive commodity chemicals and biofuels.

Fertilizer

In certain embodiments, the methods of using petroleum-based plastic-degrading larvae to produce biomass products may further include collecting the frass and dead larvae together. Specifically, in some embodiments, the frass may be collected daily from the growth chamber during the growth period. The organic residues including frass and dead larvae contain nitrogen, phosphorous, and other nutrients and elements that may be used as, without limitation, organic fertilizer and soil conditioners and may find utility in industries, without limitation, such as nursery, turf, specialty agriculture, and silviculture, or any combination thereof.

A non-limiting exemplary method for producing biomass products from insect biomass may include: (1) Waste plastic is collected from a recycling process or other process as described in section above titled “Petroleum-based Plastics.” After optionally cleaning the waste petroleum-based plastic, it may be ground up into small pieces to be used as feedstock for the larvae. (2) The larvae may be fed with the ground small plastic pieces, which may be supplemented with organic material. (3) The insect larvae may be harvested as they mature. (4) The harvested insect larvae may be used directly as live-food for chickens, birds, fishes, reptiles, and bullfrogs. The harvested insect larvae may also be used as organic fertilizer. (5) The lipids and fatty acids may be extracted from the harvested insect larvae and may be used to produce products containing lipids, oils, electricity transformer oil, or biodiesel. The residue from this extraction is a lipid- (and fatty acid) free residue. (6) Crude proteins may be extracted from this lipid-fee residue. (7) This protein-free residue may then be used for the extraction of chitin. (8) The final chitin, protein, lipid-free residue may be used as organic fertilizer or as raw material for methane production in an anaerobic digester. In some embodiments, all of the aforementioned steps are performed. In yet other embodiments, only one or more of the aforementioned steps are performed. In some embodiments, one or more of the aforementioned steps are performed in a different order. In further embodiments, additional or alternative steps are performed.

In some embodiments, the methods of using petroleum-based plastic-degrading larvae to produce biomass products further includes determining when the larvae may be ready to be harvested. In some embodiments, the petroleum-based plastic-degrading insect's fresh weight and/or dry weight is a proxy used to determine when the larvae may be harvested. In some embodiments, the fresh weight and/or dry weight from petroleum-based plastic-degrading larvae fed a petroleum-based plastics diet may be similar to larvae fed a control diet, such as one containing bran. In another embodiment, the fresh weight and/or dry weight from petroleum-based plastic-degrading larvae fed a petroleum-based plastics diet may be higher than larvae fed a control diet, such as one containing bran. In yet another embodiment, the fresh weight and/or dry weight from petroleum-based plastic-degrading larvae fed a petroleum-based plastics diet may be lower than larvae fed a control diet, such as one containing bran. In some embodiments the petroleum-based plastic-degrading insect fresh weight is at least about 10 mg to 100 mg, at least about 15 mg to 150 mg, at least about 20 mg to 200 mg, at least about 25 mg to 250 mg, or at least about 40 mg to 300 mg. In certain embodiments the petroleum-based plastic-degrading insect fresh weight is at least about 100 mg. Petroleum-based plastic-degrading insect fresh weight is at least about 10 mg, at least about 20 mg, at least about 30 mg, at least about 40 mg, at least about 50 mg, at least about 60 mg, at least about 70 mg, at least about 80 mg, at least about 90 mg, at least about 100 mg, at least about 110 mg, at least about 120 mg, at least about 130 mg, at least about 140 mg, at least about 150 mg, at least about 200 mg, at least about 250 mg, at least about 300 mg, at least about 350 mg, at least about 400 mg, at least about 450 mg, or at least about 500 mg. In some embodiments, the petroleum-based plastic-degrading insect moisture content is a percentage ranging from about 40%-80%. In reference to the insect fresh weight at which petroleum-based plastic-degrading larvae may be grown in the presence of petroleum-based plastics, “at least about” or “about” means plus or minus 2 mg.

Insects, including insects of the present disclosure, may contain one or more strains of microbe in their digestive gut, and/or salivary glands. Without wishing to be bound by theory, the presence of one or more strains of microbes in the digestive gut and/or salivary glands of the insects of the present disclosure may aid in the degradation of petroleum-based plastics. Strains of microbes present in the petroleum-based plastic-degrading insects of the present disclosure will be discussed in the next section.

Petroleum-Based Plastic-Degrading Bacteria

Certain aspects of the present disclosure relate to isolated bacteria capable of degrading petroleum-based plastics. Any petroleum-based plastic-degrading bacteria may be used to degrade petroleum-based plastics. Advantageously, petroleum-based plastic-degrading bacteria of the present disclosure are able to degrade one or more petroleum-based plastics in an amount that is at least 100 fold greater than the dry weight of the bacterial cells when the cells are grown in the presence of the one or more petroleum-based plastics for a period of time that ranges from about 10 days to about 90 days at a temperature range of about 25° C. to about 35° C., at a pH range of about 6.0 to about 7.5, and a dissolved oxygen content range of about 0.3 mg/L to about 4.0 mg/L. In one non-limiting example, it was shown that inoculating strainYT1 of the present disclosure with biomass equaling to 0.323 mg dry biomass and reduced mass of PE 0.1032 g to 0.0682 g, reduced the amount of PE by 35 mg. This was greater than 100 fold of the dry weight of bacterial cells.

Suitable isolated petroleum-based plastic-degrading bacteria include, without limitation, Bacillus tequilensis strain Enterobacter hormaechei strain YT1 (having CGMCC Accession No. 6319), strain YP1 (having CGMCC Accession No. 6318), strain Y3, strain Y4, strain Y5, strain Y6, and homologous species and/or strains thereof.

Suitable petroleum-based plastic-degrading bacteria also include, without limitation, additional strains of Bacillus tequilensis and Enterobacter honnaechei.

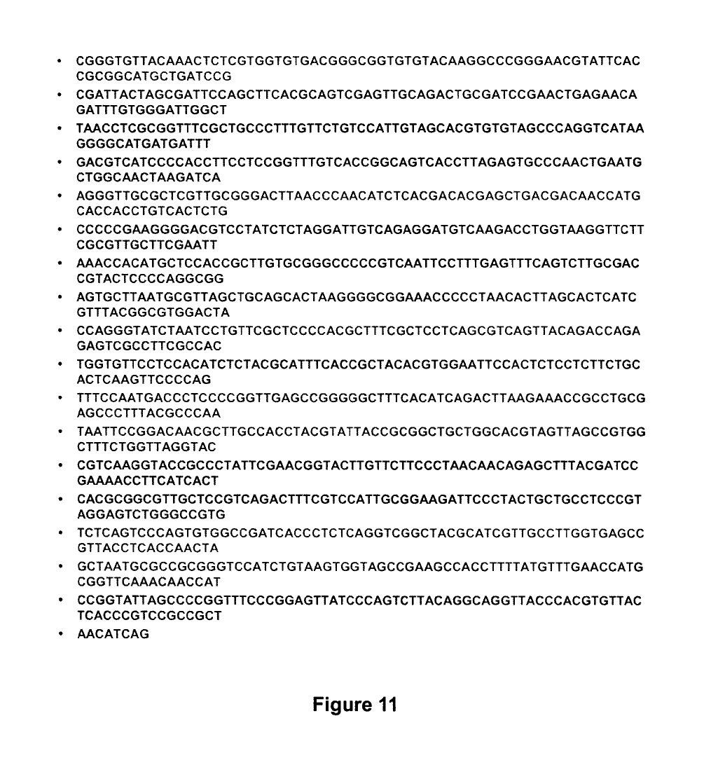

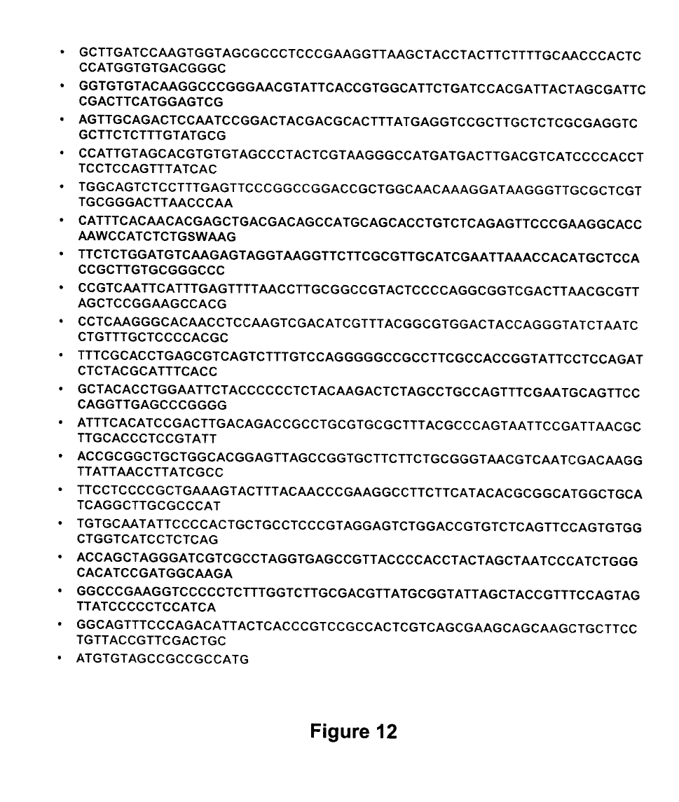

Additional suitable petroleum-based plastic-degrading bacteria may also be identified using the 16S rRNA sequence of Bacillus tequilensis strain YP1 (FIG. 11) and Enterobacter hormaechei strain YT1 (FIG. 12). Methods of using 16S rRNA sequences to identify similar bacterial strains and species are well known in the art.

In certain preferred embodiments, the bacteria are from Bacillus tequilensis strain YP1 (having CGMCC Accession No. 6318) and/or Enterobacter honnaechei strain YT1 (having CGMCC Accession No. 6319).

In certain embodiments, petroleum-based plastic-degrading bacteria of the present disclosure also include bacterial cells, such cells from Bacillus tequilensis strain YP1 (having CGMCC Accession No. 6318), that can grow (i.e., be cultured) at 30° C. on a solid medium or in a liquid medium that is prepared by filtering 200 g of smashed, cooked potato in 1 L distilled (DI) water to obtain a filtrate, and then mixing the filtrate with glucose (20 g) and agar (15 g) together with DI water to 1 L. The Liquid medium does not contain agar. The pH of the medium is adjusted to about 7.0-7.2. After autoclaving at 121° C. for 30 min, the medium is spayed on a petri dish for bacterial growth on a solid surface. The same medium without the addition of agar is used for bacterial growth in liquid phase medium.

In other embodiments, petroleum-based plastic-degrading bacteria of the present disclosure further include bacterial cells, such cells from Enterobacter honnaechei strain YT1 (having CGMCC Accession No. 6319), that can grow (i.e., be cultured) at 37° C. on a solid medium or in a liquid medium that is prepared by dissolving beef extract (3 g), peptone (10 g), and NaCl (5 g) in DI water (1 L). The solid medium contains added agar (15 g). The Liquid medium does not contain agar. The pH of the medium is adjusted to about 7.0-7.2. After autoclaving at 121° C. for 30 min, the medium is spayed on a petri dish for bacterial growth on a solid surface. The same medium without addition of agar is used for bacterial growth in liquid phase medium.

In further embodiments, isolated bacterial cells of the present disclosure may be grown under conditions that promote petroleum-based plastics degradation. The present disclosure details procedures that may be used in to isolate petroleum-based plastic-degrading bacteria and characterize their plastic-degrading ability. Furthermore, the present disclosure details methods that may be used to culture petroleum-based plastic-degrading bacteria. Cultures of plastic degrading bacteria may be grown as single isolates or grown as one or more isolates together in a consortium. The present disclosure also details compositions of isolated bacterial, microbial consortia, cultures and the like, as well as additional uses for these compositions.

Methods of Isolating Culturing Plastic-Degrading Bacteria

The present disclosure provides methods for isolating and culturing plastic-degrading bacteria of the present disclosure. In some embodiments, the disclosure provides cultures of cells from any one of the isolated bacterial strains of the present disclosure as described in the section entitled “Isolated Bacterial Strains.” In other embodiments, the disclosure provides cultures of microbial consortia containing at least one of the isolated strains of the present disclosure. In some embodiments, the disclosure provides cultures of microbial consortia further containing one or more strains where the isolated bacterial cells promote the ability of the one or more strains to degrade petroleum-based plastics, such as polystyrene (PS), polyethylene (PE), polypropylene (PP), polyvinyl chloride (PVC), polyethylene terephthalate (PET), and polycarbonate (PC).

Typical methods of bacterial isolation are well known in the art. A non-limiting example includes obtaining a source material (e.g., soil sample, water sample, municipal waste sample, and/or an insect sample of the present disclosure). Next, an enrichment step may be performed in which a selective pressure, either positive or negative may be applied to the liquid culture. Positive selection is a direct selection method that entails growing the culture in a medium that will allow only the cells of interest to growth. Negative selection is an indirect method to identify bacteria that have lost or do not possess the trait of interest. Replica plating of negatively selected bacteria on different media that allows growth to resume can be used to identify bacteria with traits of interest. Samples that have been enriched can then be plated on solid media which may again contain a selective pressure, positive or negative. Individual colonies growing on the solid media are isolated and grown to prepare stocks in order to have a source from which to study the isolate. Stocks may later be analyzed for a trait of interest, singularly or in combination with other stocks of isolates.

Common cultivation media used for bacterial growth include liquid and solid media. Liquid and solid media may be complex or defined media. Defined media has very specific recipes in which certain ingredients must be present in specific amounts, and every ingredient is known. Complex media is composed of partially digested yeast, beef, soy and additional proteins, in which the exact concentration and composition is unknown. Some examples of commonly used liquid media in bacteriology include without limitation LB, SOB, SOC, YT, TB, and SB. Agar may be added to liquid media to make solid media for isolation purposes and culture maintenance. Some examples of solid media include, without limitation, LB agar, beef extract-peptone agar, potato-glucose agar, soybean sprout extract-glucose agar, and starch agar. Liquid and solid media may have salt or other additives including, but not limited to, potassium phosphate or salts thereof, sodium chloride, manganese sulfate or salts thereof, ammonium chloride or salts thereof, ammonium nitrate or salts thereof, iron sulfate or salts thereof, and zinc sulfate or salts thereof. There are references in the literature as to appropriate media and cultivation methods for specific bacterial species (see e.g. Bergey and Boone, “Bergey's Manual of Systematic Bacteriology” and Phillips and Brock, “General microbiology: a laboratory manual.”) and one skilled in the art would be familiar with common methods used to cultivate bacteria.

Certain aspects of the present disclosure relate to isolation of bacteria from insects. In some embodiments, petroleum-based plastics degrading bacteria are isolated from the insects of the present disclosure. In yet other embodiments, petroleum-based plastic-degrading bacteria are isolated from the petroleum-based plastic-degrading insects of the present disclosure. Preferably, in certain embodiments, petroleum-based plastic-degrading bacteria are isolated from the beetles selected from the strains Tenebrio molitor Linne, Zophobas morio and Plodia interpunctella.

In some embodiments, an exemplary isolation protocol may include, without limitation, removing the guts from insects of the present disclosure as the source material and incubating the guts in basic liquid media consisting of essential salts with PE or PS as the sole carbon source. This enrichment may be serially diluted and plated on solidified agar media. The agar media may or may not contain PE or PS. Characterization of the bacterial isolates may be accomplished by testing the trait of interest. For example, an isolate may be plated on a solid media plate, and covered with a petroleum-based plastics film, such as PE or PS. The plate and film may be incubated for a period time, such as about 1 month, and then the petroleum-based plastics film examined for degradation by analytical methods or visual observation. Examples of analytical methods are mentioned in the section titled “Petroleum-based Plastic-Degrading Insects.”

Petroleum-based plastic-degrading bacteria may be identified by their ability to degrade one or more petroleum-based plastics such as polystyrene (PS), polyethylene (PE), polypropylene (PP), polyvinyl chloride (PVC), polyethylene terephthalate (PET), and polycarbonate (PC) or any other petroleum-based plastic. In certain embodiments, methods to identify petroleum-based plastics degrading insects include incubating the bacteria in question with a petroleum-based plastics and monitoring the degradation of the petroleum-based plastic. Methods and protocols to assess the degradation of petroleum-based plastics are well known in the art and include standardized protocols provided by ASTM and ISO such as ASTM 622-76(1996), ASTM D6954-04, ASTM D5988-03, ISO 14855-2:2007, and ISO 17556:2003.

Isolated Bacterial Strains

In some aspects, the present disclosure relates to one or more isolated petroleum-based plastics degrading bacterial cells of a bacterial strain, where the cells degrade at least about 100 grams of petroleum-based plastics per 1 gram dry weight of the cells when the cells are grown in the presence of petroleum-based plastics at a temperature range of about 10° C. to 40° C., pH range of about pH 6 to pH 7.5, and a dissolved oxygen concentration range of about 0.3 to 4 mg/L, for about 10 days to 30 days. In certain embodiments, the one or more petroleum-based plastic-degrading bacterial cells exhibit the characteristics of any one of the strains of the present disclosure including, without limitation, strains YT1, YP1, Y3, Y4, Y5, Y6 variants thereof, and mutants thereof.

Homologous Sequences

In certain embodiments, the present disclosure provides isolated bacterial strains that are homologous to isolated bacterial strains of the present disclosure including, without limitation, strains YT1, YP1, Y3, Y4, Y5, and Y6. Preferably, the homologous bacterial strains have all the identifying characteristics of any one of the strains of the present disclosure including, without limitation, strains YT1, YP1, Y3, Y4, Y5, and Y6. As disclosed herein, homologous bacterial strains may include mutants and variants of any of the isolated bacterial strains of the present disclosure including, without limitation, strains YT1, YP1, Y3, Y4, Y5, and Y6. To obtain mutants, a parental strain may be treated with a chemical such as N-methyl-N′-nitro-N-nitrosoguanidine, ethylmethanesulfone, or by irradiation using gamma, X-ray, or UV-irradiation, or by other means well known to those practiced in the art.

“Homology” or “homologous” as used herein refers to sequence similarity between a reference sequence and at least a fragment of a second sequence. Homologous sequences may be identified by any method known in the art, preferably, by using the BLAST tool to compare a reference sequence to a single second sequence or fragment of a sequence or to a database of sequences. As described below, BLAST compares sequences based upon percent identity and similarity.

BLAST Section

The terms “identical” or percent “identity,” in the context of two or more nucleic acids, refer to two or more sequences or subsequences that are the same. Two sequences are “substantially identical” if two sequences have a specified percentage of nucleotides that are the same (i.e., 29% identity, optionally 30%, 40%, 45%, 50%, 55%, 60%, 65%, 70%, 75%, 80%, 85%, 90%, 95%, 99% or 100% identity over a specified region, or, when not specified, over the entire sequence), when compared and aligned for maximum correspondence over a comparison window, or designated region as measured using one of the following sequence comparison algorithms or by manual alignment and visual inspection. Optionally, the identity exists over a region that is at least about 50 nucleotides in length, or more preferably over a region that is 100 to 500 or 1000 or more nucleotides in length.

For sequence comparison, typically one sequence acts as a reference sequence, to which test sequences are compared. When using a sequence comparison algorithm, test and reference sequences are entered into a computer, subsequence coordinates are designated, if necessary, and sequence algorithm program parameters are designated. Default program parameters can be used, or alternative parameters can be designated. The sequence comparison algorithm then calculates the percent sequence identities for the test sequences relative to the reference sequence, based on the program parameters. When comparing two sequences for identity, it is not necessary that the sequences be contiguous, but any gap would carry with it a penalty that would reduce the overall percent identity. For blastn, the default parameters are Gap opening penalty=5 and Gap extension penalty=2.

A “comparison window” as used herein includes reference to a segment of any one of the number of contiguous positions including, but not limited to from 20 to 600, usually about 50 to about 200, more usually about 100 to about 150 in which a sequence may be compared to a reference sequence of the same number of contiguous positions after the two sequences are optimally aligned. Methods of alignment of sequences for comparison are well known in the art. Optimal alignment of sequences for comparison can be conducted, e.g., by the local homology algorithm of Smith and Waterman (1981), by the homology alignment algorithm of Needleman and Wunsch (1970) J Mol Biol 48(3):443-453, by the search for similarity method of Pearson and Lipman (1988) Proc Natl Acad Sci USA 85(8):2444-2448, by computerized implementations of these algorithms (GAP, BESTFIT, FASTA, and TFASTA in the Wisconsin Genetics Software Package, Genetics Computer Group, 575 Science Dr., Madison, Wis.), or by manual alignment and visual inspection [see, e.g., Brent et al., (2003) Current Protocols in Molecular Biology, John Wiley & Sons, Inc. (Ringbou Ed)].

Two examples of algorithms that are suitable for determining percent sequence identity and sequence similarity are the BLAST and BLAST 2.0 algorithms, which are described in Altschul et al. (1997) Nucleic Acids Res 25(17):3389-3402 and Altschul et al. (1990) J. Mol Biol 215(3)-403-410, respectively. Software for performing BLAST analyses is publicly available through the National Center for Biotechnology Information. This algorithm involves first identifying high scoring sequence pairs (HSPs) by identifying short words of length W in the query sequence, which either match or satisfy some positive-valued threshold score T when aligned with a word of the same length in a database sequence. T is referred to as the neighborhood word score threshold (Altschul et al., supra). These initial neighborhood word hits act as seeds for initiating searches to find longer HSPs containing them. The word hits are extended in both directions along each sequence for as far as the cumulative alignment score can be increased. Cumulative scores are calculated using, for nucleotide sequences, the parameters M (reward score for a pair of matching residues; always >0) and N (penalty score for mismatching residues; always <0). For amino acid sequences, a scoring matrix is used to calculate the cumulative score. Extension of the word hits in each direction are halted when: the cumulative alignment score falls off by the quantity X from its maximum achieved value; the cumulative score goes to zero or below, due to the accumulation of one or more negative-scoring residue alignments; or the end of either sequence is reached. The BLAST algorithm parameters W, T, and X determine the sensitivity and speed of the alignment. The BLASTN program (for nucleotide sequences) uses as defaults a wordlength (W) of 11, an expectation (E) or 10, M=5, N=−4, and a comparison of both strands. For amino acid sequences, the BLASTP program uses as defaults a wordlength of 3, and expectation (E) of 10, and the BLOSUM62 scoring matrix [see Henikoff and Henikoff, (1992) Proc Natl Acad Sci USA 89(22):10915-10919] alignments (B) of 50, expectation (E) of 10, M=5, N=−4, and a comparison of both strands.

The BLAST algorithm also performs a statistical analysis of the similarity between two sequences (see, e.g., Karlin and Altschul, (1993) Proc Natl Acad Sci USA 90(12):5873-5877). One measure of similarity provided by the BLAST algorithm is the smallest sum probability (P(N)), which provides an indication of the probability by which a match between two nucleotide or amino acid sequences would occur by chance. For example, a nucleic acid is considered similar to a reference sequence if the smallest sum probability in a comparison of the test nucleic acid to the reference nucleic acid is less than about 0.2, more preferably less than about 0.01, and most preferably less than about 0.001.

Other than percentage of sequence identity noted above, another indication that two nucleic acid sequences are substantially identical is that the polypeptide encoded by the first nucleic acid is immunologically cross-reactive with the antibodies raised against the polypeptide encoded by the second nucleic acid, as described below. Thus, a polypeptide is typically substantially identical to a second polypeptide, for example, where the two peptides differ only by conservative substitutions. Another indication that two nucleic acid sequences are substantially identical is that the two molecules or their complements hybridize to each other under stringent conditions, as described below. Yet another indication that two nucleic acid sequences are substantially identical is that the same primers can be used to amplify the sequence.

Growth Conditions

Certain aspects of the present disclosure relate to the growth conditions for one or more isolated petroleum-based plastic-degrading bacterial cells of a bacterial strain. In some embodiments the isolated bacteria are grown in a suitable liquid medium and/or solid medium. In some embodiments, the growth involves a range of temperatures, pH, and dissolved oxygen concentration, over a certain period of time.

In some embodiments, the temperature at which the bacteria are grown in the presence of petroleum-based plastics ranges from at least about 1° C. to 50° C., from at least about 1° C. to 45° C., from at least about 5° C. to 50° C., 10° C. to 45° C., from at least about 15° C. to 42° C., from at least about 18° C. to 42° C., from at least about 20° C. to 40° C., from at least about 22° C. to 40° C., from at least about 24° C. to 37° C., from at least about 28° C. to 37° C., or from at least about 30° C. to 35° C. In some embodiments, the temperature at which the bacteria are grown in the presence of petroleum-based plastics is about 30° C. to 35° C. In some embodiments, the temperature at which the bacteria are grown in the presence of petroleum-based plastics is less than about 30° C. to 35° C. In some embodiments, the temperature at which the bacteria are grown in the presence of petroleum-based plastics is at least about 30° C. to 35° C. In some embodiments, the temperature at which the bacteria are grown in the presence of petroleum-based plastics is at least about 1° C., at least about 2° C., at least about 3° C., at least about 4° C., at least about 5° C., at least about 6° C., at least about 7° C., at least about 8° C., at least about 9° C., at least about 10° C., at least about 11° C., at least about 12° C., at least about 13° C., at least about 14° C., at least about 15° C., at least about 16° C., at least about 17° C., at least about 18° C., at least about 19° C., at least about 20° C., at least about 21° C., at least about 22° C., at least about 23° C., at least about 24° C., at least about 25° C., at least about 26° C., at least about 27° C., at least about 28° C., at least about 29° C., at least about 30° C., at least about 31° C., at least about 32° C., at least about 33° C., at least about 34° C., at least about 35° C., at least about 36° C., at least about 37° C., at least about 38° C., at least about 39° C., at least about 40° C., at least about 41° C., at least about 42° C., at least about 43° C., at least about 44° C., at least about 45° C., at least about 50° C., at least about 55° C., at least about 60° C., at least about 70° C., at least about 75° C. Preferably, the temperature at which the bacteria are grown in the presence of petroleum-based plastics is about 25° C. to 37° C.

In some embodiments, the pH at which the bacteria are grown in the presence of petroleum-based plastics ranges from at least about pH 3 to at least pH 10, from at least about pH 3.5 to at least pH 9.5, from at least about pH 4 to at least pH 9, from at least about pH 4.5 to at least pH 8.5, from at least about pH 5 to at least pH 8, from at least about pH 5.5 to at least pH 8, or from at least about pH 6 to at least pH 7.5. In some embodiments the pH at which the bacteria are grown in the presence of petroleum-based plastics is at least about pH 3, at least about pH 3.5, at least about pH 4, at least about pH 4.5, at least about pH 5, at least about pH 5.5, at least about pH 6, at least about pH 6.5, at least about pH 7, at least about pH 7.5, at least about pH 8, at least about pH 8.5, at least about pH 9, at least about pH 9.5, or at least about pH 10. Preferably, the pH at which the bacteria are grown in the presence of petroleum-based plastics is about pH 6 to pH 7.5. In reference to the pH at which the petroleum-based plastic-degrading bacteria are grown, “about X pH” means plus or minus 0.2 pH units. For example, a pH of about 7 ranges from 6.8 to 7.2.

In some embodiments, the dissolved oxygen concentration at which the bacteria are grown in the presence of petroleum-based plastics ranges from at least about 0 mg/mL to 20 mg/L, at least about from about 0 mg/L to 15 mg/L, at least about from about 0 mg/L to 10 mg/L, at least about from about 0 mg/L to 7.5 mg/L, at least about from about 0 mg/L to 5 mg/L, at least about from about 0 mg/L to 4 mg/L, at least about from about 0.1 mg/L to 4 mg/L, or from at least about 0.3 mg/L to 4 mg/L. In some embodiments, the dissolved oxygen concentration at which the bacteria are grown in the presence of petroleum-based plastics is at least about 0, at least about 0.1, at least about 0.2, at least about 0.3, at least about 1, at least about 2, at least about 3, at least about 4, at least about 5, at least about 6, at least about 7, at least about 7.5, at least about 8, at least about 9, at least about 10, at least about 12, at least about 14, at least about 16, at least about 18, or at least about 20 mg/L. In some embodiments the dissolved oxygen concentration at which the bacteria are grown in the presence of petroleum-based plastics is about 0.3 mg/L to 4 mg/L. In other embodiments the dissolved oxygen concentration at which the bacteria are grown in the presence of petroleum-based plastics is about less than 0.3 mg/L to 4 mg/L. Preferably, in some embodiments the dissolved oxygen concentration at which the bacteria are grown in the presence of petroleum-based plastics is about 0.3 mg/L to 4 mg/L. In reference to dissolved oxygen concentrations at which the petroleum-based plastic-degrading bacteria are grown “about X mg/L” means plus or minus 0.02 mg/L. For example, a dissolved oxygen concentration of about 2 mg/L ranges from 1.98 mg/L to 2.02 mg/L.

In some embodiments, the length of time at which bacteria are grown in the presence of petroleum-based plastics ranges from at least about 1 day to 90 days, at least about 1 day to 60 days, at least about 1 day to 40 days, at least about 5 days to 40 days, at least about 5 days to 35 days, at least about 7 days to 35 days, at least about 7 days to 30 days, at least about 10 days to 35 days, or at least about 10 days to 30 days. In some embodiments the length of time at which bacteria are grown in the presence of petroleum-based plastics ranges from about 10 days to 30 days. In other embodiments, the length of time at which bacteria are grown in the presence of petroleum-based plastics ranges from about less than 10 days to 30 days. In yet other embodiments, the length of time at which bacteria are grown in the presence of petroleum-based plastics ranges from at least about 10 days to 30 days. Preferably, in some embodiments, the length of time at which bacteria are grown in the presence of petroleum-based plastics ranges from about 10 days to 30 days.

In some embodiments, petroleum-based plastic-degrading bacteria degrade an amount of petroleum-based plastic that is about at least about 100 to at least about 10,000 fold greater than the dry weight of inoculated bacterial cells, at least about 100 to 9,000, at least about 100 to 8,000, at least about 100 to 7,000, at least about 100 to 6,000, at least about 100 to 5000, at least about 100 to 4,000, at least about 100 to 3,000, at least about 100 to 2,000, or at least 100 to 1,000 fold greater than the dry weight of inoculated bacterial cells. In some embodiments, the petroleum-based plastic-degrading bacteria degrade an amount of petroleum-based plastic that is at least about 100, at least about 200, at least about 300, at least about 400, at least about 500, at least about 600, at least about 700, at least about 800, at least about 900, at least about 1,000, at least about 2,000, at least about 3,000, at least about 4,000, at least about 5,000, at least about 6,000, at least about 7,000, at least about 8,000, at least about 9,000, or at least about 10,000 greater than the dry weight of inoculated bacterial cells. Preferably, the petroleum-based plastic-degrading bacteria degrade an amount of petroleum-based plastic that is from about 100 fold greater than the dry weight of inoculated bacterial cells to about 10,000 fold greater than the dry weight of inoculated bacterial cells.

Compositions: Isolated Strains, Microbial Consortia, and Cultures

In some aspects, the present disclosure provides compositions including one or more bacterial cells from any one of the isolated strains of the present disclosure as described in the section entitled “Isolated Bacterial Strains.” In certain embodiments, the present disclosure provides compositions including one or more cells of a bacterial strain, without limitation, such as strains YT1, YP1, Y3, Y4, Y5, Y6, and combinations thereof. In some embodiments, the compositions further include one or more strains where the one or more bacterial cells are cultured with one or more petroleum-based plastics, without limitation, such as polystyrene (PS), polyethylene (PE), polypropylene (PP), polyvinyl chloride (PVC), polyethylene terephthalate (PET), and polycarbonate (PC).

The disclosure also provides compositions including microbial consortia of the present disclosure that contain one or more bacterial cells from at least one isolated strain of the present disclosure. In some embodiments, the compositions include microbial consortia further containing one or more strains where the one or more cells promote the ability of the one or more strains to degrade petroleum-based plastics, such as polystyrene (PS), polyethylene (PE), polypropylene (PP), polyvinyl chloride (PVC), polyethylene terephthalate (PET), and polycarbonate (PC).

Microbial Consortia

Further aspects of the present disclosure relate to microbial consortia containing at least two petroleum-based plastic-degrading bacterial strains. Preferably, a microbial consortia of the present disclosure contains one or more isolated petroleum-based plastic-degrading bacterial strains of the present disclosure. Microbial consortia of the present disclosure may also contain a mixture of bacterial strains. In certain embodiments, the present disclosure provides microbial consortia including one or more cells of a bacterial strain, without limitation, such as strains YT1, YP1, Y3, Y4, Y5, Y6, and combinations thereof. Accordingly, in some embodiments, a microbial consortium of the present disclosure contains one or more cells from at least one of the isolated strains of the present disclosure and one or more strains, two or more strains, three or more strains, four or more strains, five or more strains, where the isolated strain promotes the ability of the strains in the consortium to degrade petroleum-based plastics. In some embodiments, the microbial consortia further include one or more strains where the one or more bacterial cells are cultured with one or more petroleum-based plastics such as polystyrene (PS), polyethylene (PE), polypropylene (PP), polyvinyl chloride (PVC), polyethylene terephthalate (PET), and polycarbonate (PC). Moreover, members of the microbial consortium can share synergistic relationships, e.g., the waste of one member becomes the metabolite for another.

In embodiments where the consortium contains one or more cells from at least one isolated strain of the present disclosure and one or more additional strains, the amount of degraded petroleum-based plastics, such as polystyrene (PS), polyethylene (PE), polypropylene (PP), polyvinyl chloride (PVC), polyethylene terephthalate (PET), and polycarbonate (PC), degraded by the consortium may be greater than the amount degraded by a pure culture of any one of the strains present in the consortium. The amount of degraded petroleum-based plastics, such as polystyrene (PS), polyethylene (PE), polypropylene (PP), polyvinyl chloride (PVC), polyethylene terephthalate (PET), and polycarbonate (PC) degraded by the consortium may be also greater than the amount degraded by a pure culture of one or more cells from the isolated strain of the present disclosure present in the consortium.

Methods of Using Petroleum-Based Plastic-Degrading Bacteria to Degrade Plastic

Certain aspects of the present disclosure relate to methods of using petroleum-based plastic-degrading bacteria to degrade plastic. In certain embodiments, the method of degrading one or more petroleum-based plastics may be accomplished by culturing bacterial cells, consortia, or compositions containing such cells, with one or more petroleum-based plastics under conditions sufficient to degrade said one or more petroleum-based plastics. In certain embodiments, the petroleum-based plastics are waste petroleum-based plastics. Preferably, the waste petroleum-based plastics include, without limitation, polystyrene (PS), polyethylene (PE), polypropylene (PP), polyvinyl chloride (PVC), polyethylene terephthalate (PET), and polycarbonate (PC). In some embodiments, the one or more petroleum-based plastics are used as the sole carbon source for the petroleum-based plastic-degrading bacteria. In other embodiments, the bacterial cells, consortia, and/or compositions containing such cells are cultured at a temperature range of about 15° C. to 45° C. In other embodiments, the bacterial cells, consortia, and/or compositions containing such cells are cultured for a period of time that ranges from about 1 day to about 30 days.

In certain embodiments, a bioreactor may be used in the disclosed methods of degrading petroleum-based plastics. For example, bacterial cells of the present disclosure, consortia of the present disclosure, and compositions containing such cells may be used in bioreactor. A bioreactor allows control of environmental conditions to provide optimal growth of bacterial strains and cells. A typical bioreactor setup may include providing bacterial strains, cells, consortia, and/or compositions containing such cells, and using the strains, bacterial cells, consortia, and compositions containing such cells, to create an inoculum. The inoculum may be used to seed a small, mid, or large-scale bioreactor containing petroleum-based plastics and minimal media. The internal environmental conditions of a bioreactor may be controlled and may include temperature, dissolved oxygen content, pH, carbon source, and stirring speed. The bioreactor may be a continuous-fed bioreactor or a fed-batch bioreactor. Series of pumps and valves may be used to control the input and output flow of materials and recirculate the liquid contents. Environmental conditions and input and output flow may be controlled by use of a computer and software system or controlled manually. In addition, analytical instruments may be incorporated to sample, and monitor the degradation of the petroleum-based plastics while the plastics are in the bioreactor. Mechanical device may also be used to remove solid residues after degradation. Any person skilled in the art would be well aware of methods of using bioreactors with bacterial cells, consortia, and compositions containing such cells.

Deposit of Microorganisms

Table 1 lists the strain name of isolated bacterial strains of the present disclosure, the deposit strain name of isolated bacterial strains of the present disclosure, and the accession number associated with each strain. It should be noted that the deposit strain name of each of the isolated bacterial strains listed in Table 1 is used throughout the present disclosure.

TABLE 1
Bacterial strains capable of degrading
petroleum-based plastics isolated

| Strain Name | Deposit Strain Name | Accession Number |
|---|---|---|
| YP1 | Bacillus tequilensis strain YP1 | CGMCC 6318 |
| YT1 | Enterobacter hormaechei strain YT1 | CGMCC 6319 |

Bacterial strain YP1

The isolated bacterial strain YP1 was deposited on Jul. 6, 2012 according to the Budapest Treaty in the China General Microbiological Culture Collection Center (CGMCC), Institute of Microbiology, Chinese Academy of Sciences, No. 1 West Beichen Road, Chaoyang District, Beijing 100 101. The bacterial strain YP1 was assigned CGMCC Accession Number 6318.

Bacterial Strain YT1

The isolated bacterial strain YT1 was deposited on Jul. 6, 2012 according to the Budapest Treaty in the China General Microbiological Culture Collection Center (CGMCC), Institute of Microbiology, Chinese Academy of Sciences, No. 1 West Beichen Road, Chaoyang District, Beijing 100 101. The bacterial strain YP1 was assigned CGMCC Accession Number 6319.

The isolated strains YP1 and YT1 have each been deposited under conditions that assure that access to the culture will be available during pendency of the patent application and for a period of 30 years, or 5 years after the most recent request, or for the effective life of the patent, whichever is longer. A deposit will be replaced if the deposit becomes nonviable during that period. Each of the deposits is available as required by foreign patent laws in countries wherein counterparts of the subject application, or its progeny, are filed. However, it should be understood that the availability of the deposits does not constitute a license to practice the subject invention in derogation of patent rights granted by governmental action.

The following Examples are provided to illustrate but not to limit the invention.

### EXAMPLES

### Example 1

### Isolation of Petroleum-Based Plastics-Degrading Beetles

Grain beetles of species Tenebrio molitor Linne were initially observed to consume petroleum-based plastics. Tenebrio molitor Linne was isolated and allowed to multiply for further experiments. Tenebrio molitor Linne larvae were tested for their ability to degrade expanded polystyrene (EPS) in experimental incubators. Larvae were pre-reared on bran, corn, or other agricultural products, and were transferred to their respective experimental incubators after the 2nd to 3rd instar growth stage.

Incubation conditions were 25° C., 85% humidity, 16:8 hours of light and dark cycle, respectively, and a larval density of 3.5 kg/m² based on initial larvae weight. A total of 200 pre-reared larvae, without regard to gender, were placed in each experimental incubator for a total of 20 days, after which sampling took place.

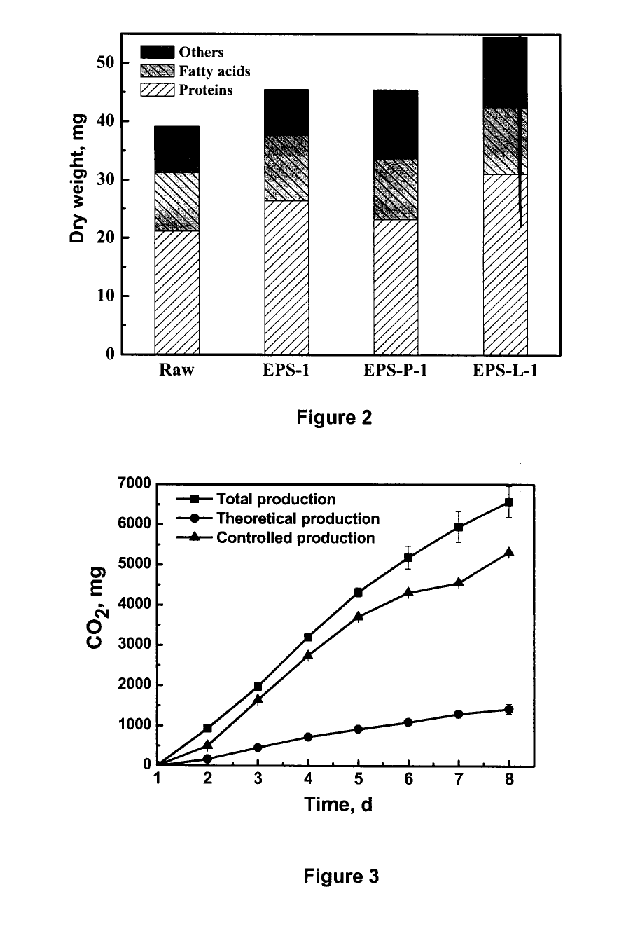

Four duplicate experiments were performed in parallel (for a total of eight incubators), with each experiment varying only in the material fed to the larvae during the 20-day incubation. The four various feeding conditions were 1) bran only (70% moisture content), 2) EPS only, 3) EPS plus potato (<5% potato on a dry weight basis), and 4) EPS plus fresh vegetable leaves (<5% fresh leaves on a dry weight basis). Supplementary potato and fresh vegetables leaves were provided on a daily basis, except for the EPS only group. The supplementary vegetable products were consumed by the larvae within 6-8 hours of feeding. As shown in FIG. 2, supplements of vegetable products enhanced the growth of the larvae.

Weight, Protein, Fatty Acid Determinations

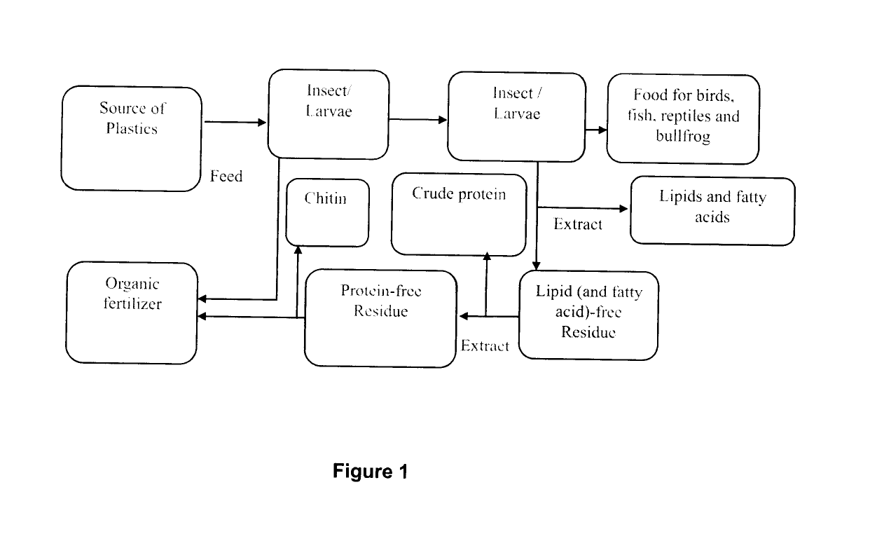

After 20 days, larvae were harvested, weighed, and extraction of lipids, proteins, and chitins were performed. FIG. 1 depicts an exemplary process for the harvesting of insects and processing of insects into biomass products.

Lipids

The live larvae were euthanized with 75% ethanol, and then washed with distilled water. The cleaned larval samples were then frozen at −80° C., and then lyophilized in a vacuum freeze drier. Then the dried larval samples were ground to powder under liquid nitrogen. 1 gram of dry larval powder was filed in an extraction thimble and extracted with 35 ml petroleum ether in a soxhelt extractor for 7-8 h at 50 d. Then the petroleum ether was volatilized from mixture for reused. The extracted lipid was harvested and the residuals solids were used for protein extraction.

Proteins

The 10 gram lipid-free residual solids were dissolved in 100 ml 1% NaOH for approximately 2 hours at 80° C. The suspension was centrifuged at 3,000 rpm for 15 min to pellet the undissolved solids. The upper aqueous phase containing the proteins was removed and neutralized by adding 1.46M HCl until the sample reached a pH range of 4.0-4.4. At this iso-electric pH range, the proteins precipitated easily and were collected by dialysis.

Chitins

The 10 gram residual lipid-free and protein-free powders were dissolved in 100 ml 1M HCl for approximately 1 hour at room temperature to removal ash. The suspension was centrifuged to separate the undissolved solids, and the supernatant was discarded. The remaining solids were neutralized by rinsing with distilled water and then lyophilized to a dry yellow-brown powder. The powder was decolorized by the addition of 100 ml 10% NaClO or 30% H₂O₂ for approximately 4 hours at room temperature. The mixture was then neutralized with water. After neutralization the mixture was lyophilized to a yellow-powder. This powder, containing the chitin, was deacetylated by adding 100 ml 12M NaOH and incubated at 90° C. for 6 h. This deactylated mixture was washed with water and then filtered. The washed residual was lyophilized to a white powder consisting primarily of chitosan (degree of deacetylation: >80%).

Results

The increase in weight was significant in all experimental groups at day 20 compared to the initial weight on day 0. Larvae fed with potato-supplemented EPS (EPS-P-1), and leaves-supplemented EPS (EPS-L-1) exhibited more weight gain than larvae grown on EPS alone (EPS-1) (Table 2, FIG. 2). The amount of feed consumed per total weight gain was similar between groups. For example, larvae consuming only EPS (EPS-1) gained 0.30 g of weight per g of EPS consumed, while the bran only control group (Bran-1) gained 0.35 mg of weight per g of bran consumed. This confirmed that the larvae used EPS as a carbon and energy source for the growth of their biomass.

TABLE 2
Weight change and biomass contents of larvae grown on different feedings for 20 days

| | Fresh weight, | Dry weight, | Moisture, | Dry protein, mg and % | | Dry fatty acids, mg and % | | Dry others, mg and % | | |
|---|---|---|---|---|---|---|---|---|---|---|
| Group | mg | mg | % | Weight, | Percentage | Weight | Percentage | Weight | Percentage | P % |
| Raw | 114.45 | 39.14 | 65.67 | 21.14 | 54.02 | 10.12 | 25.85 | 7.88 | 20.13 | 1.25 |
| EPS-1 | 130.08 | 45.49 | 65.03 | 26.37 | 57.97 | 11.31 | 24.87 | 7.81 | 17.16 | 0.74 |
| EPS-P-1 | 128.31 | 45.43 | 64.59 | 23.16 | 50.98 | 10.51 | 23.13 | 11.76 | 25.89 | 1.19 |
| EPS-L-1 | 153.88 | 54.47 | 64.60 | 30.99 | 56.89 | 11.45 | 21.02 | 12.03 | 22.09 | 0.41 |
| Bran-1 | 171.16 | 76.53 | 55.29 | 38.34 | 50.10 | 22.91 | 29.93 | 15.28 | 19.97 | 0.82 |

In Table 2, “Raw” refers to original larva; “EPS” refers to larva fed with EPS debris; “P” refers to potato; and “L” refers to vegetable leaves.

Compositional analysis of the fatty acid and amino acid content of larvae biomass grown on EPS are presented in Table 3. These results show that the composition of larvae grown on EPS differs from that of larvae that are not grown on EPS.

TABLE 3
Fatty acid composition of larvae grown on EPS after 20 day incubation

| Fatty Acids | Chemical Formula | Content, % | Amine Acids | Content, % |
|---|---|---|---|---|
| Capric acid, 10:0 | CH₃(CH₂)₈COOH | 0.05 | Asp | 7.21 |
| Lauric acid, 12:0 | CH₃(CH₂)₁₀COOH | 0.73 | Thr | 3.27 |
| Tridecanoic acid, 13:0 | C₁₃H₂₆O₂ | 0.23 | Ser | 3.76 |
| Myristic acid, 14:0 | C₁₄H₂₈O₂ | 3.95 | Glu | 10.17 |
| Pentadecanoic acid, 15:0 | C₁₅H₃₀O₂ | 0.74 | Gly | 4.93 |
| Palmitic acid, 16:0 | C₁₆H₃₂O₂ | 13.17 | Ala | 7.21 |
| Heptadecanoic acid, 17:0 | C₁₇H₃₄O₂ | 0.71 | Cys | 0.43 |
| Stearic acid, 18:0 | C₁₈H₃₆O₂ | 6.04 | Val | 5.03 |
| Arachidic acid, 20:0 | C₂₀H₄₀O₂ | 0.25 | Met | 1.73 |
| 14:1Δ9 | C₁₄H₂₆O₂ | 0.74 | Ile | 3.82 |
| 16:1Δ7 | C₁₆H₃₀O₂ | 1.63 | Leu | 6.60 |
| 16:1Δ9 | C₁₆H₃₀O₂ | 3.57 | Tyr | 6.12 |
| 16:2Δ1, 10 | C₁₆H₂₈O₂ | 1.39 | Phe | 3.52 |
| 17:1Δ7 | C₁₇H₃₂O₂ | 0.70 | Lys | 4.83 |
| 18:1Δ9 | C₁₈H₃₄O₂ | 26.70 | Arg | 3.87 |
| 18:2Δ9, 12 | C₁₈H₃₂O₂ | 32.72 | His | 2.58 |
| 18:3Δ9, 12, 15 | C₁₈H₃₀O₂ | 5.72 | Pro | 5.50 |
| 20:1Δ11 | C₂₀H₃₈O₂ | 0.62 | | |
| 20:2Δ11, 13 | C₂₀H₃₆O₂ | 0.36 | | |

Based on the results in FIG. 2 and Table 2, the total biomass of the larvae grown on EPS-1, EPS-P-1 and EPS-L-1 increased after 20 day incubation; although they were slightly lower than that on bran. Addition of vegetables (EPS-L-1) was helpful for the weight increase (FIG. 2). Supplementation with potato did not improve the biomass accumulation. Analysis of fatty acid and amine acid contents in the biomass of larvae growth on EPS indicated the biomass is rich in lipid and proteins.

Similar to our observations with the Pyralidae moth larvae Plodia interpunctella, other larvae, including Carabidae grain beetle larvae Tenebrio molitor Linne and Tenebrionidae darkling beetle larvae Zophobas morio were also observed to consume petroleum-based plastics as well. The larvae grown on PS and PE averagely increased 0.3 g dry weigh per g plastics consumed.

### Example 2

### Degradation of EPS to CO₂ by Beetle Larvae X

Two incubators were prepared with 200 larvae in each one. Larvae were pre-reared as described in Example 1. Incubation conditions were as previously described in Example 1.

The larvae from the first incubator were fed with expanded polystyrene (EPS, labeled as H-EPS) and the second incubator was not fed with any food under starvation condition (labeled as Control). No vegetable supplementation was used. The CO₂ produced by larvae respiration in both incubators were collected. The amount of CO₂ from EPS that was broken down into CO₂ was measured by precipitating CO₂ respired by the larvae in the incubator fed with EPS minus CO₂ respired by the larvae in the Control incubator. Briefly, CO₂-free air was delivered and flowed through the incubators; effluent air was collected and flowed through a solution of 1M NaOH to remove any CO₂ and convert it to sodium carbonate, which was then measured as TIC (Total Inorganic Carbon). The NaOH solution was replaced daily. The TIC, as measured by sodium carbonate, was used to calculate the amount of CO₂ produced.

Larval frass (feces), was collected after 8 day incubation from both incubators. First, the larvae were carefully separated from the EPS and debris was gently removed from the larvae by blowing air using a rubber suction bulb. The cleaned larvae were transferred to another incubator free from frass, and reared for an additional 24 hours prior to the next frass collection. Frass was analyzed by various means as outlined below.

FIG. 3 shows the accumulation of CO₂ for 8 days by the larvae in Control container and the container with EPS (H-EPS), as well as the estimated net CO₂ accumulation from EPS based on the amount loss of EPS. On day 8, the total CO₂ accumulated by the H-EPS larvae is significantly higher than that of the Control group. The CO₂ accumulated from the control group reached plateau at day 6 indicating that these larvae had consumed their internal energy reserves (such as lipids, proteins, carbohydrates) and started dying. The net CO₂ accumulation from EPS is calculated based on the difference between the Control and H-EPS larvae on day 8. This strongly suggested that the larvae fed with EPS converted it to CO₂. The mineral efficiency of PS by larvae was calculated by the equation: (TCO₂−KCO₂)/WCO₂×100%, where TCO₂=the total accumulated CO₂ of H-EPS; KCO₂=the total accumulated CO₂ of control groups; and WCO₂=the theoretical accumulated CO₂ of EPS weight loss. In this test, the TCO2 was 6571.4 mg, the KCO2 was 5310.8 mg and the WCO2 was 1420.3 mg. Thus, the percentage of EPS converted to CO2 was 88.7%.

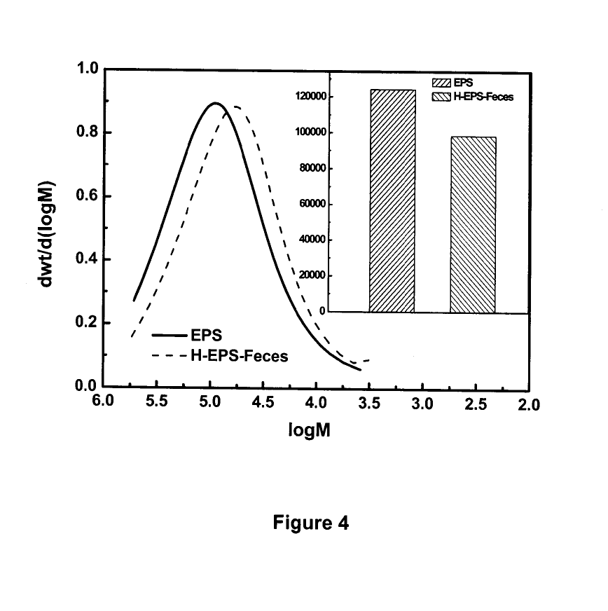

Chemical analysis of frass from larvae fed with EPS showed that larvae were able to depolymerize EPS. Gel permeation chromatography (GPC) of raw EPS and frass from larvae fed with EPS (H-EPS-Feces) showed a 20% reduction in average polymer distribution (FIG. 4). Average molecular weights of raw EPS and H-EPS-Feces were calculated to be 124,213 and 98,330 Daltons, respectively, by the GPC-associated software package, Breeze. This change in molecular weight strongly suggested that the EPS was depolymerized as it passed through the larval gut and digestive system.

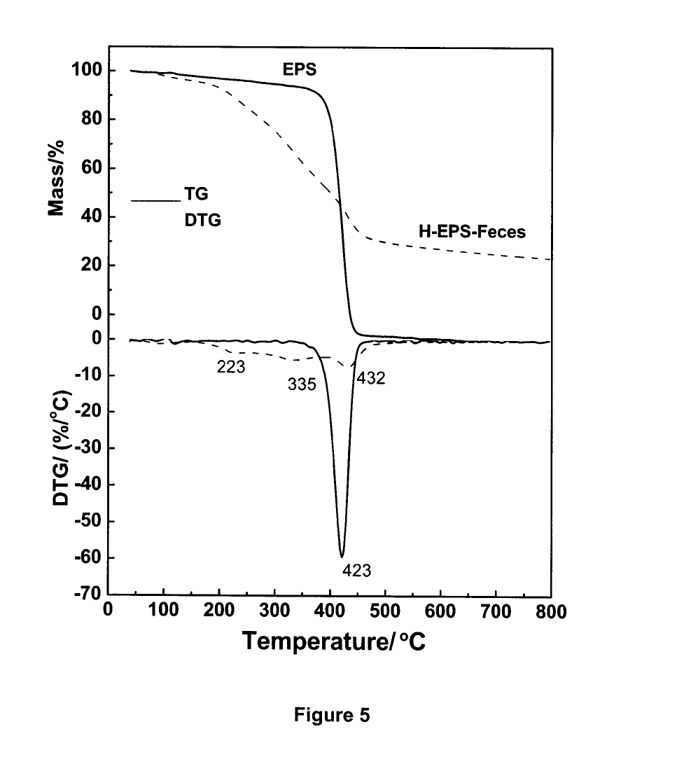

Differential temperature gradient (DTG) analysis demonstrated and significant change in the composition of raw EPS after it was consumed by the larvae and excreted as frass. Thermal decomposition of H-EPS-Feces commenced at a much lower temperature compared to raw EPS and did not have a strong inflection point indicating significant changes in the chemical structure (FIG. 5).

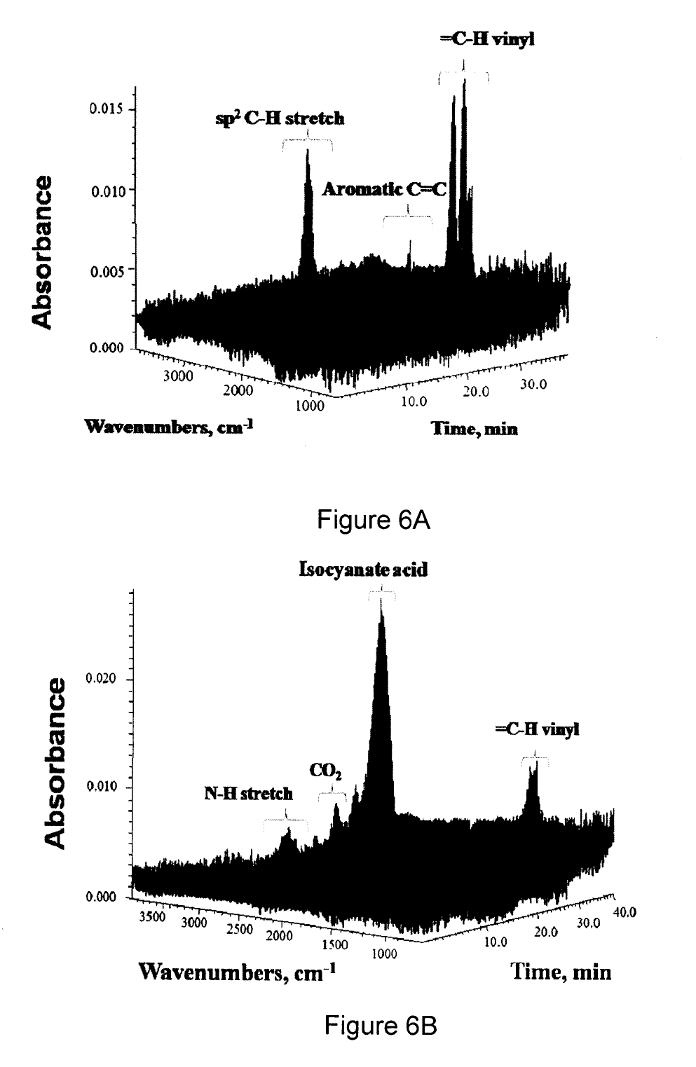

The Fourier transform infrared (FTIR) spectroscopy results comparing raw EPS to H-EPS-Feces indicated a significant change by loss of certain spectral peaks characteristic of EPS, and addition of others not normally present (FIG. 6). These results indicate a change in the chemical bonds normally present in EPS as a result of passing through the larval gut and digestive system.

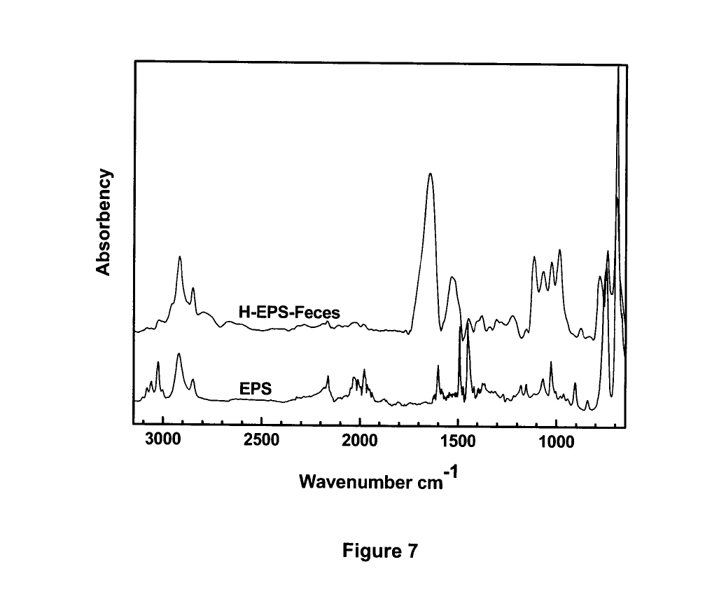

FTIR analysis of gaseous species evolved during the thermal decomposition of EPS (FIG. 7A) and H-EPS-Feces (FIG. 7B), show differences the FTIR spectra for these two samples. These differences are further evidence that EPS and H-EPS-Feces have very different chemical bonding present, for example with the presence of nitrogen-bound carbon compounds (isocyanate peak) in H-EPS-Feces sample of FIG. 7B.

The cumulative results from GPC, DTG, and FTIR are strongly suggestive that raw EPS, consumed by larvae X, becomes depolymerized as it passes through the gut and digestive system, and becomes chemically-altered relative to raw EPS.

### Example 3

### Degradation of PE by Beetle Larvae and Isolation of Larval Gut Bacteria

For this Example, the incubation conditions were 25° C., 75% humidity, and dark, respectively. 15 pre-reared Pyralidae Plodia interpunctella larvae were placed into a PE bag (length×width: 14.8 cm into a, film thickness: 0.035 mm) mixed with 150 g sterile millet (water content: 8%). The larvae were then incubated for 28 days and then the frass was collected for analysis.

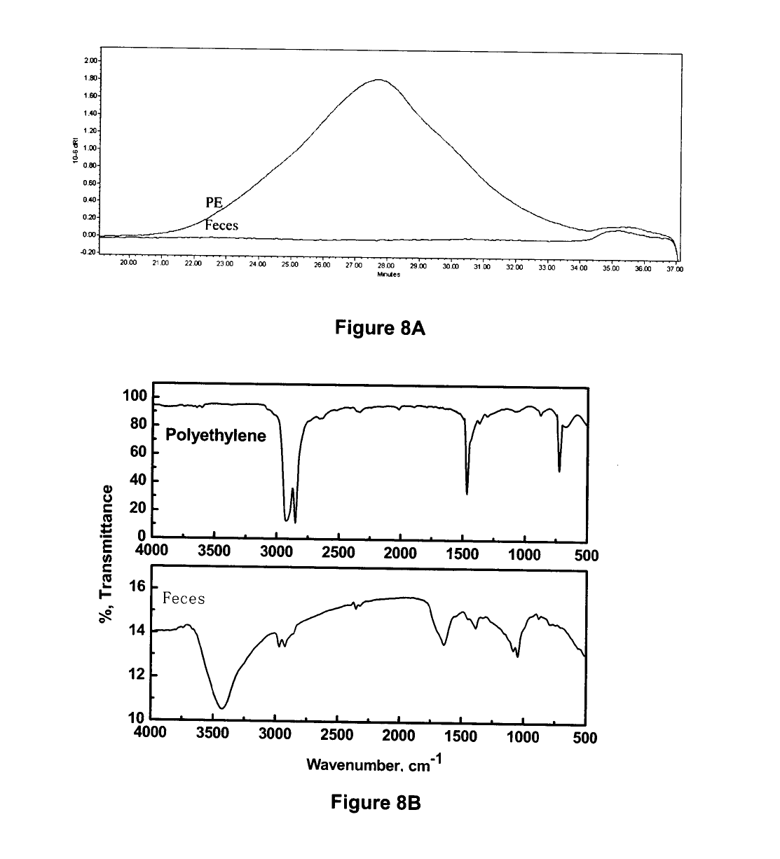

High temperature gel permeation chromatography (HT-GPC) analysis indicated that Plodia interpunctella larvae were able to completely depolymerize PE. Comparison of raw PE (dashed line) to frass from PE-fed larvae (solid line) showed an absence of high molecular weight polymer compounds (FIG. 8A).

The Fourier transform infrared (FTIR) spectroscopy of raw PE (FIG. 8B) and frass from PE-fed larvae (FIG. 8C) supported depolymerization of PE by the loss of spectral peaks characteristic of raw PE, and additional of other peaks non characteristic of raw PE.

The cumulative results from HT-GPC, and FTIR are strongly suggestive that raw PE, consumed by larvae Plodia interpunctella, becomes depolymerized as it passes through the gut and digestive system, and the resulting frass is chemically distinct from raw PE.

Isolation of Bacteria Endogenous to Larval Gut

In order to determine the contribution of endogenous gut-bacteria to the ability of larva Plodia interpunctella to degrade plastics, bacterial strains were isolated from the gut of Plodia interpunctella larvae.

The gut from 50 Plodia interpunctella larvae were removed and incubated for 50 days in a basic liquid medium with PE film as the sole carbon source. This enrichment was serially diluted and plated on solidified agar media (described below). After incubation, the colonies were picked with sterile toothpicks and placed into liquid medium for further growth or short-term preservation at 4° C.

Basic liquid medium was prepared with DI water (1000 mL) and contained: 0.7 g KH₂PO₄, 0.7 g K2HPO₄, 0.7 g MgSO₄.7H₂O, 1.0 g NH₄NO₃, 0.005 g NaCl, 0.002 g FeSO₄.7H₂O, 0.002 g ZnSO₄.7H₂O, 0.001 g MnSO₄.H₂O. Sterilization was accomplished by autoclaving at 121° C. for 20 min prior to use.

LB agar medium was prepared by adding 0.7 g KH₂PO₄, 0.7 g K2HPO₄, 0.7 g MgSO₄.7H₂O, 1.0 g NH₄NO₃, 0.005 g NaCl, 0.002 g FeSO₄.7H₂O, 0.002 g ZnSO₄.7H₂O, 0.001 g MnSO₄.H₂O and 15 g agar into 1000 mL DI water in an Erlenmeyer flask. Sterilization was accomplished by autoclaving at 121° C. for 20 minutes prior to distribution into petri dishes.

Six bacterial strains (YT1, YP1, Y3, Y4, Y5, and Y6) were isolated from the gut of Plodia interpunctella larvae, and were identified by 16S rDNA sequencing (Table 4). Phenotypic characteristics and their ability to degrade either PE or PS are indicated as well.

TABLE 4
Bacterial isolated from Plodia interpunctella. (A = Enterobacter
spp., C = Psudomonas spp, B = Bacillus spp. Y1 = YT1; Y2 = YP1)

| Strain | Gram | Shape | Spore-forming | Growth substrate | Genus |
|---|---|---|---|---|---|
| Y6 | negative | rod | no | PE, PS | A |
| Y5 | negative | rod | no | PE, PS | A |
| Y4 | negative | rod | no | PE, PS | A |
| Y3 | negative | rod | no | PE, PS | C |
| Y2 | negative | rod | no | PE, PS | A |
| Y1 | positive | Short rod | yes | PE, PS | B |

Degradation of PE and PS was measured by incubating bacteria in the presence of one of these plastics. A single bacterial colony was picked from a petri dish with agar medium, transferred into 50 mL LB medium, and then incubated for 24 hrs at 30° C. in a shaking incubator at 220 rpm. One ml of the culture was plated evenly on LB agar medium plate, which was subsequently covered with a PE film (5×5 cm) or PS film. The plate was incubated for 28 days at 28-30° C. with a relative humidity of 85%. At the end of the 28 day incubation, the PE film was removed for examination by scanning electron microscopy (SEM). The degradation of PS was characterized by observation of formation of bacterial colonies on EPS, which is submerged in the solid agar medium.

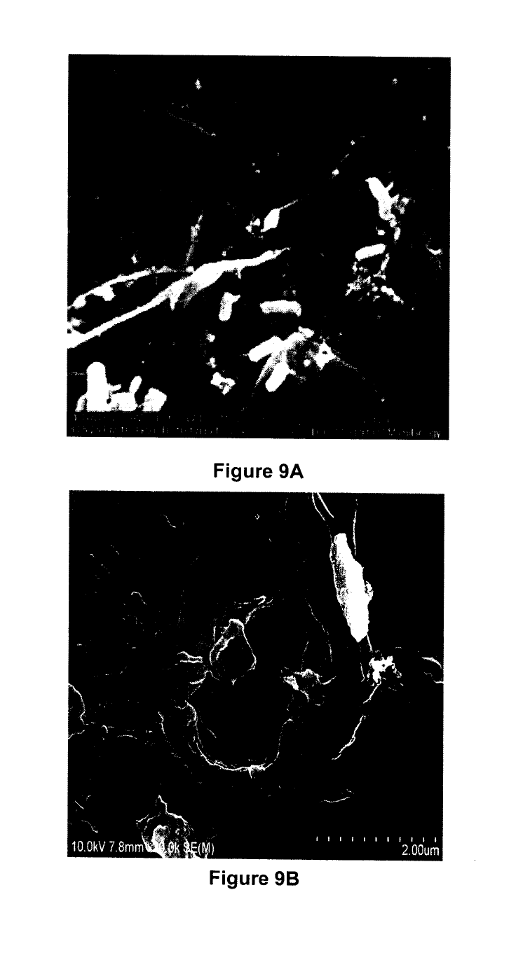

A mixed consortium of the six bacterial strains indicated surface modification of the PE film as indicated by SEM (FIG. 9A). Experimental results using one of these strains, YP1 showed similar results (FIG. 9B).

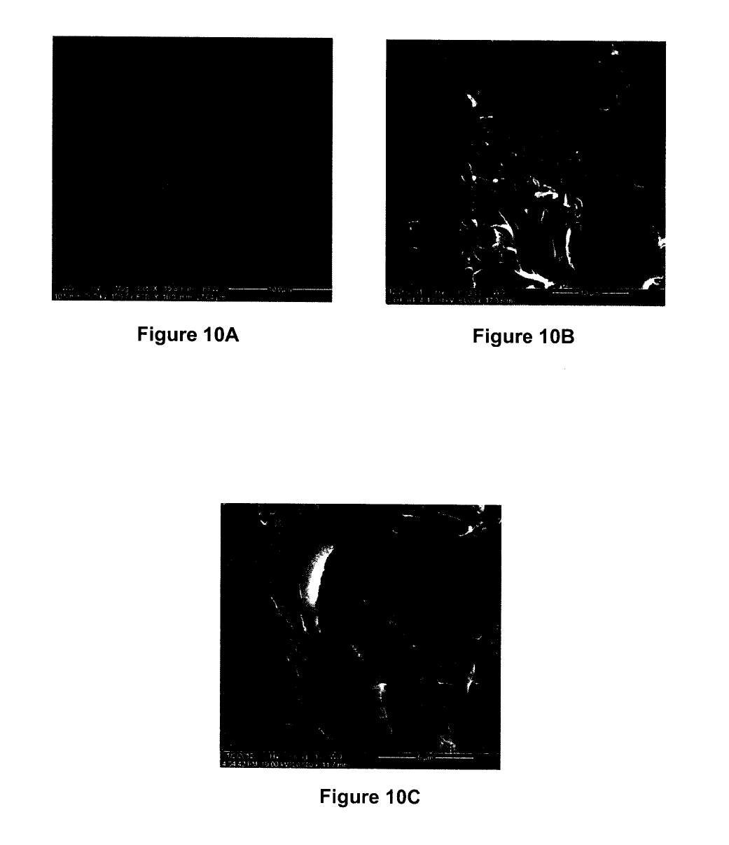

The results of SEM on PE samples are shown in a Control (FIG. 10A), a DI water-rinsed PE film after 28 days of incubation with bacterial strain YT1 (FIG. 10B), and a non-rinsed PE film after 28 days of incubation with bacteria strain YT1 (FIG. 10C). FIG. 10C shows the attachment of bacteria strain YT1 to the surface of the PE film, and FIG. 10B shows the destruction of the PE surface due to incubation with the bacteria relative to Control PE film in FIG. 10A.

The physical and mechanical properties of the PE film after degradation by bacterial strain YP1 was investigated and measured. Mechanical properties, such as tensile strength, elongation at break, and Young's modulus of the PE film were measured on a universal testing machine (AGS-X, Shimadzu Inc., Japan) according to ASTM D882-02. The contact angles were determined by the sessile drop technique using Millipore water and a contact angle microscope OCA 40 (Data Physics, Germany) at room temperature and ambient humidity. The volume of liquid drop was 5 μL at the dropping rate of 0.1 μL/s. All contact angles were measured on both sides of the drop and the results were averaged. Each contact angle reported in this work was an average of the values obtained for a minimum of three points on the sample surface. Surface energy was calculated by the contact angle measured by the water and formamide.

As is detailed in Table 5, after incubating PE film with bacterial strain YP1 for 28 days, the maximum load decreased by 57.14%, tensile strength decreased by 56.68%, elongation at break increased 211.77%, contact angle decreased by 23.25%, and surface energy increased by 46.98%.

TABLE 5
Comparison of mechanical properties of PE film
after biodegradation by strain YP1 with Control
(Unit of surface energy is mN/m, Y2 = YP1)

| Item | Control | Y2 | Change, % |
|---|---|---|---|
| Max. load (Newtons) | 4.41 | 1.89 | −57.14 |
| Tensile strength (MPa) | 20.20 | 8.75 | −56.68 |
| % Elongation at break | 113.91 | 355.14 | 211.77 |
| Contact angle | 97.2 | 74.6 | −23.25 |
| Surface energy | 19.88 | 29.22 | 46.98 |

Cumulatively, the results from SEM and mechanical property tests indicate that bacterial strain YP1 significantly changed the PE film through its attachment to the surface of the film.

We claim:

1. One or more isolated petroleum-based plastic-degrading bacterial cells of a bacterial strain, wherein said cells degrade one or more petroleum-based plastics in an amount that is at least 100 fold greater than the dry weight of said cells when said cells are grown in the presence of the one or more petroleum-based plastics for a period of time that ranges from about 10 days to about 90 days at a temperature range of about 25° C. to about 37° C., at a pH range of about 6.0 to about 7.5, and a dissolved oxygen content range of about 0.3 mg/L to about 4.0 mg/L.

2. One or more isolated petroleum-based plastic-degrading bacterial cells of claim 1, wherein said one or more bacterial cells exhibit all the identifying characteristics of a strain deposited with CGMCC as Accession No. 6318; variants of the strain deposited with CGMCC as Accession No. 6318, wherein the variants have all the identifying characteristics of the CGMCC No. 6318 strain; and mutants of the strain deposited with CGMCC as Accession No. 6318, wherein the mutants have all the identifying characteristics of the CGMCC No. 6318 strain.

3. One or more isolated petroleum-based plastic-degrading bacterial cells of claim 1, wherein said one or more bacterial cells exhibit the characteristics of cells of bacterial strain YP1 deposited with CGMCC as Accession No. 6318.

4. One or more isolated petroleum-based plastic-degrading bacterial cells of claim 1, wherein said one or more bacterial cells exhibit all the identifying characteristics of a strain deposited with CGMCC as Accession No. 6319; variants of the strain deposited with CGMCC as Accession No. 6319, wherein the variants have all the identifying characteristics of the CGMCC No. 6319 strain; and mutants of the strain deposited with CGMCC as Accession No. 6319, wherein the mutants have all the identifying characteristics of the CGMCC No. 6319 strain.

5. One or more isolated petroleum-based plastic-degrading bacterial cells of claim 1, wherein said one or more bacterial cells exhibit the characteristics of cells of bacterial strain YT1 deposited with CGMCC as Accession No. 6319.

6. One or more isolated petroleum-based plastic-degrading bacterial cells of any one of claims 1-5, wherein the one or more bacterial cells are capable of degrading one or more petroleum-based plastics.

7. The one or more isolated petroleum-based plastic-degrading bacterial cells of any one of claims 1-6, wherein the bacterial cells are isolated from an insect selected from the group consisting of Tenebrio molitor Linne, Zophobas morio, and Plodia interpunctella.

8. The one or more isolated petroleum-based plastic-degrading bacterial cells of claim 1 or claim 6, wherein the one or more petroleum-based plastics are waste petroleum-based plastics.

9. The one or more isolated petroleum-based plastic-degrading bacterial cells of claim 1, claim 6, or claim 8, wherein the one or more petroleum-based plastics are selected from the group consisting of polystyrene (PS), polyethylene (PE), polypropylene (PP), polyvinyl chloride (PVC), polyethylene terephthalate (PET), and polycarbonate (PC).

10. The one or more isolated petroleum-based plastic-degrading bacterial cells of claim 6, wherein the one or more bacterial cells degrade an amount of the one or more petroleum-based plastic that ranges from about 100 grams of the one or more petroleum-based plastics per gram of dry weight of said cells to about 10,000 grams of the one or more petroleum-based plastics per gram of dry weight of said cells.

11. A composition comprising the one or more bacterial cells of any one of claims 1-10.

12. A composition comprising one or more cells of at least one of a bacterial strain selected from the group of YT1, YP1, and combinations thereof.

13. The composition of claim 12, wherein the at least one or more cells are of at least two bacterial strains, at least three bacterial strains, at least four bacterial strains, at least five bacterial strains, or six of the bacterial strains selected from the group of YT1, and YP1.

14. The composition of any one of claims 11-13, further comprising one or more petroleum-based plastics, wherein the one or more bacterial cells are cultured with said one or more petroleum-based plastics.

15. An isolated microbial consortium comprising the one or more bacterial cells of any one of claims 1-10.

16. An isolated microbial consortium comprising one or more bacterial cells of a bacterial strain selected from the group of YT1, YP1, and combinations thereof.

17. A composition comprising the isolated microbial consortium of claim 15 or 16.

18. The composition of claim 17, further comprising one or more petroleum-based plastics, wherein the isolated microbial consortium is cultured with said one or more petroleum-based plastics.

19. A method of degrading one or more petroleum-based plastics, comprising: culturing the composition of any one of claims 11-13 and 17 with one or more petroleum-based plastics under conditions sufficient for said composition to degrade said one or more petroleum-based plastics.

20. The method of claim 19, wherein the one or more petroleum-based plastics are the sole carbon source.

21. The method of claim 19 or claim 20, wherein the one or more petroleum-based plastics are waste petroleum-based plastics.

22. The method of any one of claims 19-21, wherein the one or more petroleum-based plastics are selected from the group consisting of polystyrene (PS), polyethylene (PE), polypropylene (PP), polyvinyl chloride (PVC), polyethylene terephthalate (PET), and polycarbonate (PC).

23. The method of any one of claims 19-22, wherein said composition is cultured for a period of time sufficient to degrade said one or more petroleum-based plastics.

24. The method of any one of claims 19-23, wherein the composition is cultured for a period of time that ranges from about 10 days to about 90 days.

25. The method of any one of claims 19-24, wherein said composition is cultured at a temperature range of about 15° C. to about 45° C.

26. A method of degrading one or more petroleum-based plastics, comprising: contacting larvae of at least one petroleum-based plastic-degrading insect with one or more petroleum-based plastics; and
growing said larva with the one or more petroleum-based plastics under conditions sufficient for the larvae to degrade the one or more petroleum-based plastics, thereby yielding a degraded petroleum-based plastic product.

27. The method of claim 26, wherein said larvae are grown with the one or more petroleum-based plastics for a period of time sufficient to degrade an amount of the one or more petroleum-based plastics that is at least 10 fold greater than the weight of said larvae.

28. The method of claim 27, wherein said larvae are grown with the one or more petroleum-based plastics for a period of time that ranges from about 2 hours to about 480 hours, from about 2 hours to about 360 hours, from about 2 hours to about 240 hours, from about 2 hours to about 120 hours, from about 2 hours to about 96 hours, from about 2 hours to about 72 hours, from about 2 hours to about 48 hours, or from about 2 hours to about 24 hours.

29. The method of any one of claims 26-28, wherein the larvae are provided at a larval density that ranges from about 2.0 kg/m² to about 10 kg/m².

30. The method of any one of claims 26-28, wherein the larvae are provided at a larval density that ranges from about 3.5 kg/m² to about 6.0 kg/m².

31. The method of any one of claims 26-30, wherein the larvae are grown with the one or more petroleum-based plastics at a temperature that ranges from about 20° C. to about 35° C.

32. The method of any one of claims 26-30, wherein the larvae are grown with the one or more petroleum-based plastics at a temperature that ranges from about 25° C. to about 28° C.

33. The method of any one of claims 26-32, wherein the larvae are grown with the one or more petroleum-based plastics at a moisture content that ranges from about 60% to about 99%.

34. The method of any one of claims 26-32, wherein the larvae are grown with the one or more petroleum-based plastics at a moisture content that ranges from about 80% to about 90%.

35. The method of any one of claims 26-34, wherein the larvae are grown with the one or more petroleum-based plastics at a light to dark ratio of about 16:8 or a light to dark ratio of about 14:10.

36. The method of any one of claims 26-35, wherein the larvae convert the one or more petroleum-based plastics to carbon dioxide (CO₂).

37. The method of any one of claims 26-36, wherein the degraded petroleum-based plastic product has a molecular weight that is at least 20% lower than the molecular weight of a corresponding petroleum-based plastic that has not been degraded.

38. The method of any one of claims 26-37, further comprising growing the larvae with a source of nutrients.

39. The method of claim 38, wherein the source of nutrients is selected from the group consisting of vegetables, leafy vegetables, fruits, tubers, roots, fresh vegetable leaves, potatoes, carrots, corn, and combinations thereof.

40. The method of claim 38 or claim 39, wherein the nutrients are selected from the group consisting of nitrogen, phosphorous, a vitamin, water, and combinations thereof.

41. The method of any one of claims 26-37, wherein the one or more petroleum-based plastics are waste petroleum-based plastics.

42. The method of any one of claims 26-41, wherein the one or more petroleum-based plastics are selected from the group consisting of polystyrene (PS), polyethylene (PE), polypropylene (PP), polyvinyl chloride (PVC), polyethylene terephthalate (PET), and polycarbonate (PC).

43. The method of any one of claims 26-42, wherein the petroleum-based plastic-degrading insect is a grain beetle.

44. The method of any one of claims 26-42, wherein the petroleum-based plastic-degrading insect is selected from the group consisting of Tenebrio molitor Linne, Zophobas morio, and Plodia interpunctella.

45. A method of producing a biomass product, comprising: contacting larvae of at least one petroleum-based plastic-degrading insect with one or more petroleum-based plastics; and growing said larva with the one or more petroleum-based plastics under conditions sufficient for the larvae to metabolize the one or more petroleum-based plastics, wherein the larvae utilize the metabolized one or more petroleum-based plastics to produce at least one biomass product.

46. The method of claim 45, wherein said larvae are grown with the one or more petroleum-based plastics for a period of time that ranges from about 2 hours to about 480 hours, from about 2 hours to about 360 hours, from about 2 hours to about 240 hours, from about 2 hours to about 120 hours, from about 2 hours to about 96 hours, from about 2 hours to about 72 hours, from about 2 hours to about 48 hours, or from about 2 hours to about 24 hours.

47. The method of claim 45 or claim 46, wherein the larvae are provided at a larval density that ranges from about 2.0 kg/m² to about 10 kg/m².

48. The method of claim 45 or claim 46, wherein the larvae are provided at a larval density that ranges from about 3.5 kg/m² to about 6.0 kg/m².

49. The method of any one of claims 45-48, wherein the larvae are grown with the one or more petroleum-based plastics at a temperature that ranges from about 20° C. to about 35° C.

50. The method of any one of claims 45-48, wherein the larvae are grown with the one or more petroleum-based plastics at a temperature that ranges from about 25° C. to about 28° C.

51. The method of any one of claims 45-50, wherein the larvae are grown with the one or more petroleum-based plastics at a moisture content that ranges from about 60% to about 99%.

52. The method of any one of claims 45-50, wherein the larvae are grown with the one or more petroleum-based plastics at a moisture content that ranges from about 80% to about 90%.

53. The method of any one of claims 45-52, wherein the larvae are grown with the one or more petroleum-based plastics at a light to dark ratio of about 16:8 or a light to dark ratio of about 14:10.

54. The method of any one of claims 45-53, further comprising growing the larvae with a source of nutrients.

55. The method of claim 54, wherein the source of nutrients is selected from the group consisting of vegetables, leafy vegetables, fruits, tubers, roots, fresh vegetable leaves, potatoes, carrots, corn, and combinations thereof.

56. The method of claim 54 or claim 55 wherein the nutrients are selected from the group consisting of nitrogen, phosphorous, vitamin, water, and combinations thereof.

57. The method of any one of claims 45-56, further comprising growing the larvae with a juvenile hormone or neotenin to stimulate larval growth.

58. The method of any one of claims 45-57, wherein the one or more petroleum-based plastics are waste petroleum-based plastics.

59. The method of any one of claims 45-58, wherein the one or more petroleum-based plastics are selected from the group consisting of polystyrene (PS), polyethylene (PE), polypropylene (PP), polyvinyl chloride (PVC), polyethylene terephthalate (PET), and polycarbonate (PC).

60. The method of any one of claims 45-59, wherein the petroleum-based plastic-degrading insect is a grain beetle.

61. The method of any one of claims 45-59, wherein the petroleum-based plastic-degrading insect is selected from the group consisting of Tenebrio molitor Linne, Zophobas morio, and Plodia interpunctella.

62. The method of any one of claims 45-61, wherein the at least one biomass product is selected from the group consisting of lipids, fatty acids, proteins, chitin, and combinations thereof.

63. The method of any one of claims 45-61, further comprising harvesting the larvae.

64. The method of claim 63, wherein the harvested larvae is utilized as feed.

65. The method of claim 63, wherein the at least one biomass product is extracted from the harvested larvae.

66. The method of claim 65, wherein the at least one biomass product is utilized as feedstock in the production of at least one commodity chemical.

67. The method of claim 66, wherein the at least one commodity chemical is a biofuel.

68. The method of claim 65, wherein the at least one biomass product is utilized as feedstock in the production of an emulsifier, a surfactant, a lubricant, a flocculant, a transformer oil, food, feed, a pharmaceutical, a fertilizer, a cleaning product, a healthcare product, a cosmetics product, or combinations thereof.

69. The method of any one of claims 45-61, further comprising harvesting excrement from the larvae.

70. The method of claim 69, wherein the excrement is utilized as fertilizer.
